(19) United States
(12) Patent Application Publication
(10) Pub. No.: US 2018/0039507 A1
(43) Pub. Date: Feb. 8, 2018

(54) SYSTEM AND METHOD FOR MANAGEMENT OF A VIRTUAL MACHINE ENVIRONMENT

(71) Applicant: INTIGUA, INC., Newton, MA (US)

(72) Inventors: Tomer LEVY, Kfar-Saba (IL); Shimon Hason, Brookline, MA (US)

(73) Assignee: INTIGUA, INC., Newton, MA (US)

(21) Appl. No.: 15/684,514

(22) Filed: Aug. 23, 2017

Related U.S. Application Data
(63) Continuation of application No. 13/228,262, filed on Sep. 8, 2011, now abandoned.
(60) Provisional application No. 61/382,005, filed on Sep. 12, 2010.

(51) Int. Cl. G06F 9/455; G06F 9/50

(52) U.S. Cl. CPC G06F 9/45558; G06F 9/5027; G06F 2009/45595; G06F 2209/509; G06F 2209/5017

(57) ABSTRACT

A system and method for operating an agent. A policy may be generated based on an analysis of a code segment of an agent, analysis of the execution and/or installation of an agent. An interaction with the agent may be intercepted. The interaction may be analyzed according to the policy. A machine for performing an operation related to the interaction may be selected. A proxy on the selected machine may perform the operation and return a result to the agent. In some embodiments, a request to perform a task may be intercepted. A first portion of the task may be performed by an agent and a second portion of the task may be performed by a proxy.

### CROSS REFERENCE TO RELATED APPLICATIONS

This application is a continuation application of U.S. patent application Ser. No. 13/228,262, filed on Sep. 8, 2011, which claims the benefit of U.S. Provisional Application No. 61/382,005, filed on Sep. 12, 2010 and entitled “Methods and Systems for Distributed Execution of Agents in a Virtual Machine Environment”, which is incorporated in its entirety herein by reference.

### BACKGROUND OF THE INVENTION

With development of computing systems, management of large scale software installations has become a challenging task. Modern computing systems may involve distributed software modules and/or applications, e.g., in an organization, community or data center. Management and maintenance of large scale and/or distributed software applications or systems typically involve tasks such as update procedures, monitoring, version control etc. For example, management of software installations in an organization may include updating software modules or monitoring various aspects on a large number of servers and/or user computers.

In another example, management of a virtual machine (VM) environment may involve management of a large number of virtual machines. The term “virtual machine” (VM) generally refers to an isolated operating system (also referred to as a “guest operating system”) that runs on a physical machine. A VM may be a software implementation of a machine (e.g., a computer) that executes programs as if it were a physical computer, having its own resources, e.g., a central processing unit (CPU), memory (e.g., random access memory (RAM)), hard disk and network interface cards (NICs).

A number of VMs may be (and typically are) executed on a single hardware machine. For example, a number of different operating systems (e.g., Windows™, Unix™ and Mac OS™) may run on a single hardware machine. One of the essential characteristics of a VM is that applications, programs or services running inside a VM are limited to (or by) the resources provided by the VM. Accordingly, VM technology offers a number of advantages. For example, consolidation may be realized by utilizing a single hardware server in order to execute a number of operating systems. Other advantages may be redundancy and fail over.

However, management of large scale computing, software and/or VM systems may pose a number of challenges. For example, various services (e.g., backup, monitoring and/or software updates) may need to be managed and/or performed for, or even on, each computer in an organization or on each VM installed on a single computer or on a number of hardware machines.

### SUMMARY OF THE INVENTION

Embodiments of the invention may analyze code of an agent to produce a policy and/or configuration. A policy and/or configuration may be based on monitoring and/or analysis of an execution and/or installation of an agent. One or more policy and/or configuration parameters may be used to intercept an interaction with an agent on a first machine, process data included in the interaction and select a machine on which operations are to be performed. In a specific embodiment, an interaction with an agent on a first virtual machine may be intercepted and operations required to be performed may be determined. A virtual machine on which the operations are to be performed may be selected based on a policy, configuration and other considerations. Based on a policy, performance of task may be divided between an agent on a local machine and a proxy on a remote machine. A result or response may be generated by including results from a proxy and an agent in a combined result.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1A shows a schematic block diagram of a system according to embodiments of the present invention;

FIG. 1B shows a schematic block diagram of a system according to embodiments of the present invention;

FIG. 1C shows a schematic block diagram of a system according to embodiments of the present invention;

FIG. 1D shows a schematic block diagram of a system according to embodiments of the present invention;

FIG. 1E shows a schematic block diagram of a system according to embodiments of the present invention;

FIG. 1F shows a schematic block diagram of a method according to embodiments of the present invention;

FIG. 2A shows a schematic block diagram of a method according to embodiments of the present invention;

FIG. 2B shows a block diagram of operations according to embodiments of the present invention;

FIG. 2C shows a block diagram of operations according to embodiments of the present invention;

FIG. 2D shows a block diagram of a memory according to embodiments of the present invention;

FIG. 2E shows a block diagram of a memory and related operations according to embodiments of the present invention;

FIG. 2F shows a block diagram of a memory and related operations according to embodiments of the present invention;

FIG. 2G shows a block diagram of a memory and related operations according to embodiments of the present invention;

FIG. 2H shows a schematic block diagram of a system according to embodiments of the present invention;

FIG. 2I shows a schematic block diagram of a system according to embodiments of the present invention;

FIG. 3 shows a schematic block diagram of a system according to embodiments of the present invention;

FIG. 4A shows a schematic block diagram of a system according to embodiments of the present invention;

FIG. 4B shows a schematic block diagram of a system and memory according to embodiments of the present invention;

FIG. 4C shows a block diagram of a memory and related components according to embodiments of the present invention; and

FIG. 4D shows a schematic block diagram of a system according to embodiments of the present invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

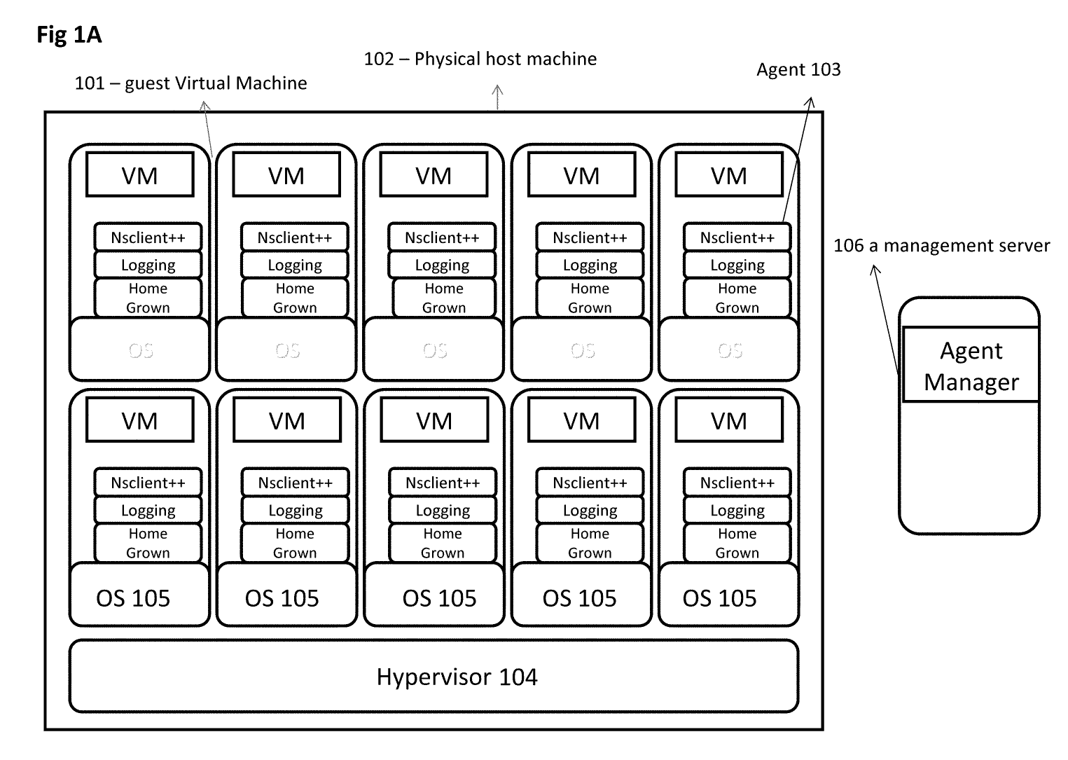

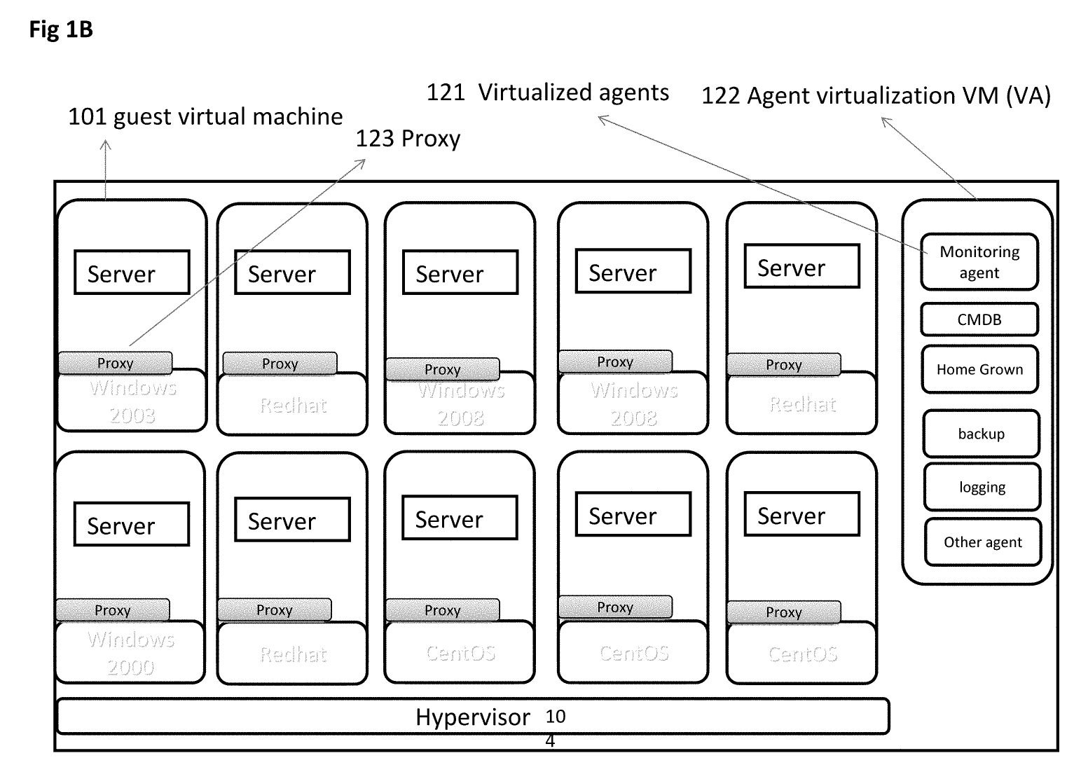

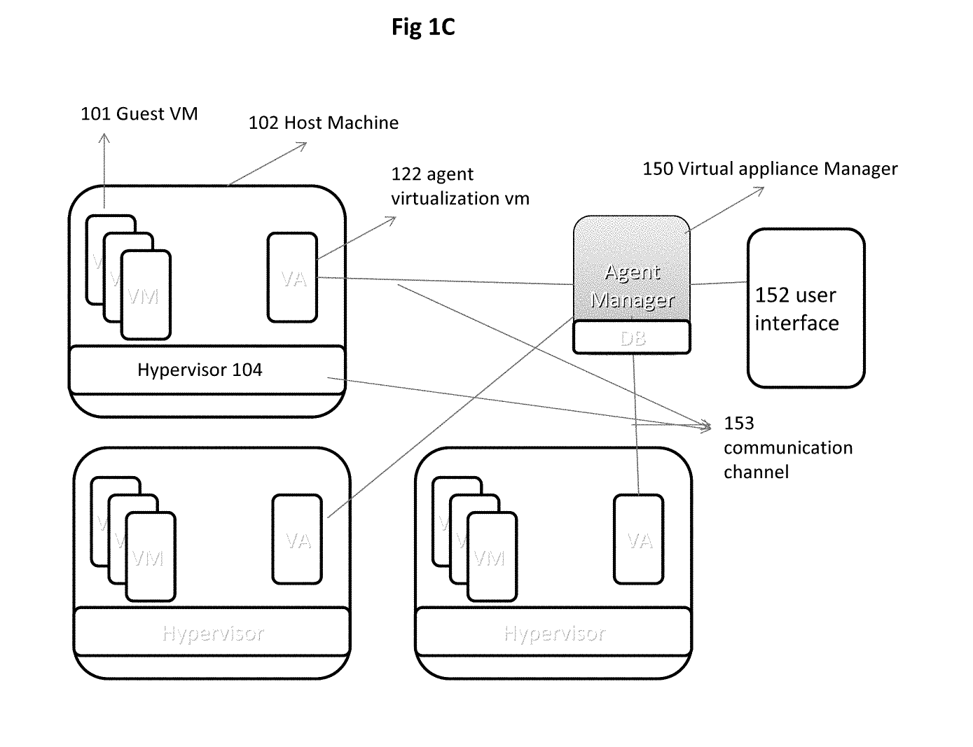

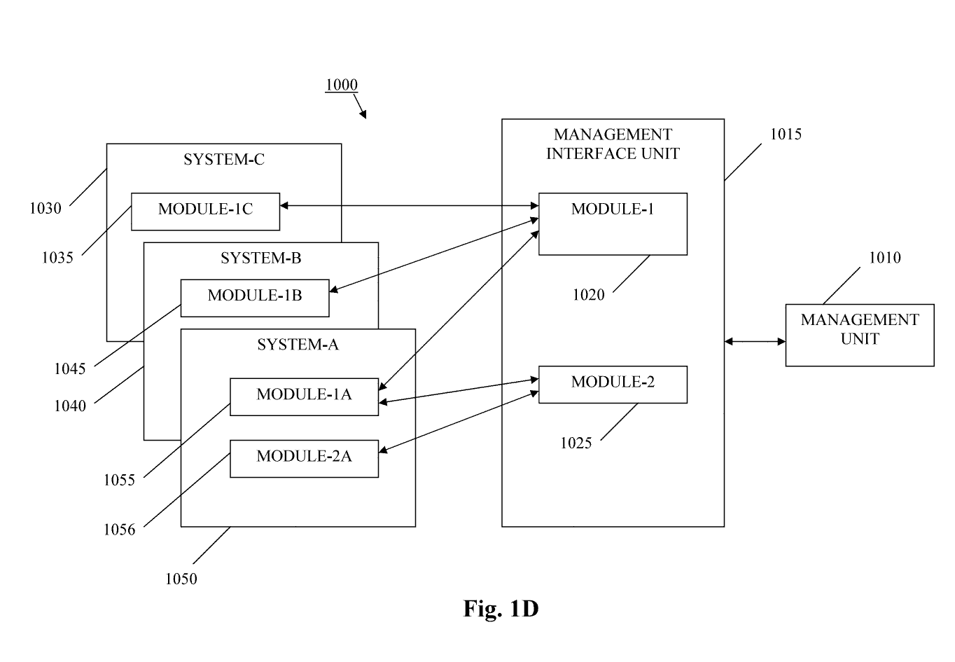

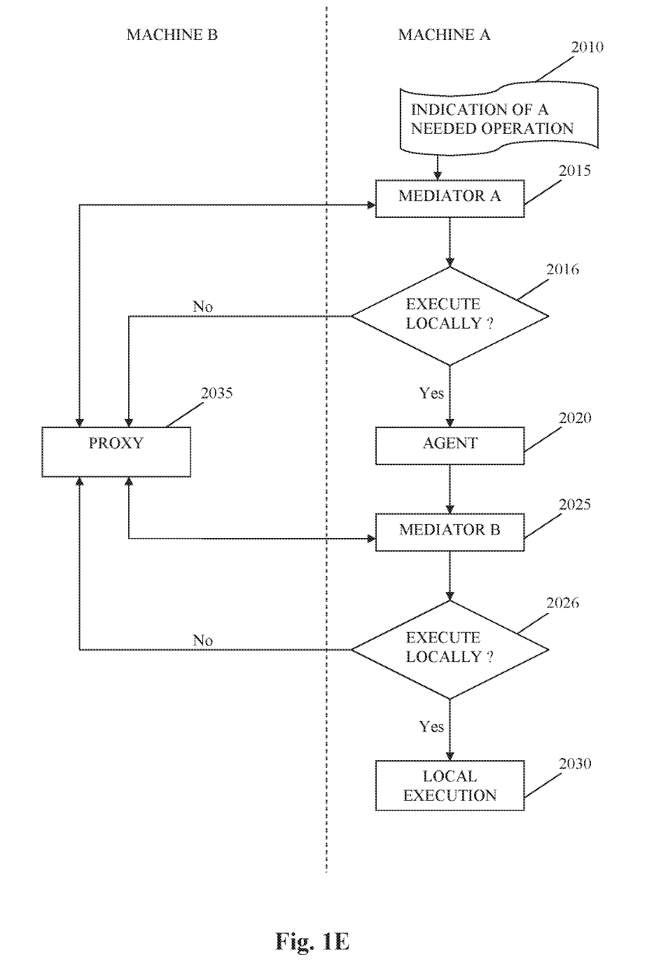

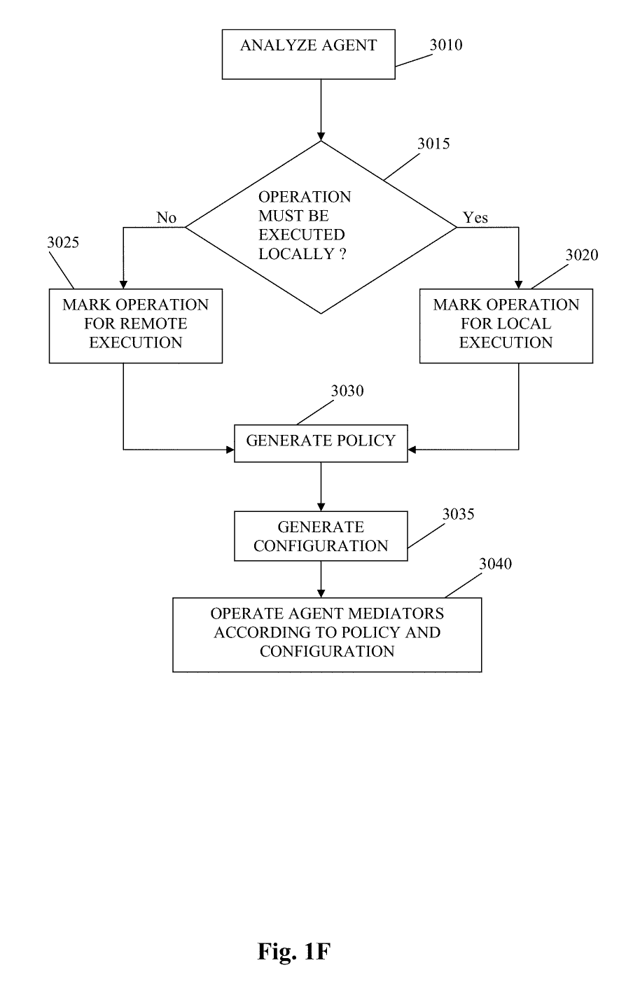

Reference is made to FIG. 1D which shows a schematic block diagram of a system 1000 according to embodiments of the present invention. As shown, a system or setup may include a management unit 1010, a management interface unit 1015 and a plurality of systems 1030, 1040 and 1050. As further shown, management interface unit 1015 may include module-1 1020 and module-2 1025. It will be understood that any number of modules such as modules 1020 and 1025 may be included in management interface unit 1015.

As shown, system-A 1050 may include module-1A 1055 and module-2A 1056, system-B 1040 may include module-1B 1045 and system-C 1030 may include module-1C 1035. For the sake of simplicity and clarity, only a small number of modules included in systems 1030, 1040, 1050 and in management interface unit 1015 are shown. However, it will be understood that systems 1030, 1040, 1050 and management interface unit 1015 may include any number of modules such as modules 1035, 1045, 1055, 1056, 1020 and 1025.

Management unit 1010 may be any suitable system, software, device or combination thereof. For example, management unit 1010 may be a graphical user interface (GUI) application configured to interact with management interface unit 1015 and/or with any modules in management interface unit 1015, for example, management unit 1010 may directly interact with modules 1020 and 1025. Management interface unit 1015 may be any suitable system, device or application. For example, management interface unit 1015 may a computer on which modules 1020 and 1025 are executed. In another embodiment, management interface unit may be a VM installed on a server that may also host one or more of systems 1030, 1040 and 1050. It will be understood that system 1000 as shown in FIG. 1D is an exemplary system and that other systems or configurations may applicable, for example, components of system 1000 as shown in FIG. 1D may be differently distributed. For example, management unit 1010 may be included in, or executed on, the same device or system hosting management interface unit 1015.

Module-1 1020 and module-2 1025 may be any suitable modules. For examples, modules 1020 and 1025 may be software applications, e.g., agents that may be configured to interact with modules 1035, 1045, 1055 and 1056. In addition to interacting with other modules (e.g., 1035, 1045, 1055 and 1056), modules 1020 and 1025 may be configured to execute various tasks, e.g., as requested by management unit 1010. For example, module-1 1020 may be a backup or monitoring agent that may perform backup or monitoring or asset management operations related to systems 1020 or 1030. As described herein, modules 1020 and 1025 may receive requests to perform tasks or operations and may perform required operations, cause other modules to perform the tasks or share an execution of tasks with other modules.

Systems 1030, 1040 and 1050 may be any applicable computing systems or computing machines. For example, system-C and system-B may be virtual machines installed on a common computer and system-A may be a user desktop computer or a server. Systems 1030, 1040 and 1050 may be geographically distant from one another and/or from management interface unit 1015 or they may be included in a single device (e.g., systems 1030, 1040 and 1050 may be virtual machines installed on a single server). Any suitable communication network may be used in order to enable systems 1030, 1040 and 1050 to interact with management interface unit 1015 and/or with modules 1020 and 1025. Modules 1055 and 1056 may be any applicable modules installed in system-A 1050. For example, module-1A 1055 may be a backup application that may backup data stored on system-A 1050 and module-2A 1056 may be a monitoring agent or application that may monitor aspects such as central processing unit (CPU) utilization or storage capacity of system-A 1050. In another embodiment, modules 1055 and 1056 may be proxies configured to receive instructions or requests from modules 1020 and 1025 and perform operations on behalf of modules 1020 and 1025. Modules 1045 and 1035 may be similar to modules 1055 and 1056.

As shown by the arrows connecting module-1 1020 and modules 1035, 1045 and 1055, a single module in management interface unit 1015 may interact with a plurality of modules on a plurality of systems. For example, module-1 1020 may receive a request to perform a task from management unit 1010 and cause some or all of modules 1035, 1045 and 1055 to perform the task. Accordingly, a user may issue a single request to perform an operation or task, the request may be received by a first module (e.g., module-1 1020) and the request may be forwarded to a plurality of modules on a plurality of systems. A plurality of results produced by performing a respective plurality of tasks on a plurality of systems may be aggregated and returned to management unit 1010. For example, upon receiving a request from management unit 1010, module-1 1020 may cause module-1A 1055 and module-1B 1045 to perform a task or operation and return results to module-1 1020. Module-1 1020 may combine results received from modules 1055 and 1045 and send the combined results to management unit 1010.

As shown by the arrows connecting module-1A 1055 with modules 1020 and 1025, a number of modules in management interface unit 1015 may interact with a single module on one of systems 1030, 1040 or 1050. For example, module-2A 1056 may be a proxy that may serve, or act for or on behalf of both module-1 1020 and module-2 1025. For example, module-2A 1056 may monitor a performance of system-A 1050 based on a request received from module-1 1020 and, either concurrently or at a different time, provide information related to a network activity based on a request received from module-2 1025.

Management unit 1010 (and/or a user operating management system 1010) may be unaware of any interaction between modules 1020 and 1025 and other components of system 1000. For example, a user may use management unit 1010 in order to interact with module-1 1020, e.g., in order to setup configuration parameters, however, the user may be unaware that module-1 1020 passes received configuration parameters to one or more modules on systems 1030, 1040 and/or 1050. In another example, possibly using management unit 1010, a user may instruct module-2 1025 to perform a task and return results. However, instead of performing the task, or in addition to performing some of the task as instructed, Module-2 1025 may cause module-2A 1056 to perform all or some of the task and return a result to module-2 1025. Module-2 1025 may process a result received from module-2A 1056 and forward the processed result to management unit 1010.

In other embodiments, scenarios or cases, after receiving a request to perform a task (e.g., from management unit 1010), module-2 1025 may process the request and, based on the processing, perform a first portion of the task and further cause module-2A 1056 to perform a second portion of the task. Module-2A 1056 may perform the second portion of the task and return a result to module-2 1025. Module-2 1025 may combine a result received from module-2A with any data, parameter or information, e.g., with a result of an execution of the first portion of the task by module-2 1025 and may send the combined results to management unit 1010. Accordingly, management unit 1010 may be unaware that a number of modules, possibly executing on a number of systems were involved in an execution of a requested task or in producing a response to a request issued by management unit 1010.

Reference is made to FIG. 1E which shows a schematic block diagram of a system according to embodiments of the present invention. As shown, a system may include a first and second machines (machines A and B). It will be understood that although only two machines are shown for the sake of clarity, systems according to embodiments of the invention may include a large number of machines. For example, a typical embodiment may include a first machine such as machine A shown in FIG. 1E and a large number of virtual machines that may be similar to machine B. Likewise, although a single agent and proxy are respectively shown in machines A and B, it will be understood that embodiments of the invention are not limited in this respect. In fact, in a typical embodiment of the invention, machine A may include dozens of agents 2020 and a plurality of machines B may each include a large number of proxies 2035.

As shown, a system may include a mediator A 2015, a mediator B 2025, an agent 2020, a local execution unit or module 2030 on a first machine (machine A) and a proxy 2035 on a second machine (machine B). Agent 2020 may be similar to module-1 1020 and/or module-2 1025 described with respect to FIG. 1D. Proxy 2035 may be similar to any one of module-1A 1055, module-2A 1056, module-1B 1045 and/or module-1C 1035 described herein with reference to FIG. 1D. For example, agent 2020 may be a monitoring, backup or update module and proxy 2035 may be a module specifically designed and configured to perform, on remote machine B, tasks and/or operations instead, for, or on behalf of, agent 2020. In other embodiments, agent 2020 may be related to asset management, security, logging, job scheduling, automation or inventory management.

Accordingly, embodiments of the invention are not limited by the nature of agent 2020 or the specific tasks agent 2020 performs. Embodiments of the invention may be applicable to any suitable agent. Tasks and/or operations normally performed by any agent may performed by a proxy as described herein. Any task or operation that would normally be performed by any suitable agent may be intercepted and/or analyzed and a proxy may be caused to perform at least a portion of the task or operation. For example, a management module may request a security agent on a first computer to apply a security measure. The request may be intercepted, analyzed and a proxy on a second machine may be caused to apply the security measure on the second machine. In another example, a request to provide asset management information directed to an agent may be redirected to a proxy. In yet another embodiments, a request for inventory data may be intercepted and part of the inventory information in a response may be collected by a proxy. For example, agents provided by a third party may be analyzed as described herein and may be executed according to embodiments of the invention, e.g., agent 2020 may be a commercial product provided by any vendor. In some embodiments, agent 2020 may be treated as a black-box in the sense that its inner workings may not be known nor changed. By analyzing an operation, installation and/or execution of an agent, any agent may be included in embodiments of the invention without changing the code of the agent.

By monitoring and analyzing operations performed by an agent, e.g., resources accessed by the agent and interactions with the agent (e.g., involving an OS, hardware components etc.) embodiments of the invention may be able to encapsulate an operation of agent such that any interaction of the agent with any resource or entity is controlled. For example, any message sent to an agent may first be obtained by embodiments of the invention (e.g., a mediator as described herein), may be analyzed and tasks to be performed according to the message may be divided between the agent and a proxy. Likewise, any message sent by the agent or any attempt of the agent to access a resource (e.g., a file, a disk drive or a configuration register) may be intercepted and a proxy may be caused to perform any operation or task based on intercepted interactions.

As shown by 2010, an indication of a needed or requested operation may be received by mediator A 2015. For example, an indication of a needed operation may be a request or command directed to agent 2020. An indication of a needed operation 2010 may be included in a message destined to agent 2020 or it may be a software or hardware or software interrupt or event configured to cause agent 2020 to perform an operation, task or procedure. Mediator A 2015 may be configured to intercept or otherwise obtain any communication or interaction with agent 2020. For example, mediator A 2015 may intercept any messages sent to agent 2020 (e.g., by management unit 1010 or by an operating system executed on machine A or by an application on Machine A). Mediator A 2015 may examine a message destined to agent 2020 or any attempt to interact with agent 2020 and may process and/or analyze the interaction. For example, mediator A 2015 may be provided with a policy, configuration file or parameter or other information and may analyze a message directed to agent 2020 based on a policy or configuration parameter. As shown by 2016, mediator A 2015 may determine whether an operation is to be performed locally or on a remote machine. For example, based on a policy and/or a configuration file, mediator A 2015 may determine that reading a specific file is to be performed on the local machine A by agent 2020, and may further determine, e.g., in another case, that monitoring a CPU utilization is to be performed on the remote machine B, by proxy 2035. In some cases, mediator 2015 may alter the original operation and cause an execution of the altered operation on local machine A or on remote machine B. In other embodiments of the invention, mediator 2015 may decide to ignore an operation or trigger multiple operations based on a single operation of the agent 2020. In yet other embodiments, mediator A may cause operations to be performed on both local Machine A and remote machine B.

Accordingly, a method according to embodiments of the invention may include intercepting an interaction involving an agent, where the interaction is related to at least one operation. For example, an interaction may be a request sent from a management system to an agent, an interrupt (e.g., either hardware or software detected or produced by a kernel), a message etc. The method may include analyzing the interaction according to a policy to produce an analysis result. For example, the analysis result may be a first list of operations that are to be performed on the machine on which the agent is running and a second list of operations that are to be performed on a remote machine. Accordingly, for one or more operations, the method may include selecting, based on the analysis result, a virtual machine on which the operation is to be performed. The method may include causing a proxy on the selected virtual machine to perform the operation. Upon completion of performance of an operation, the proxy may return a result to an agent and the agent may combine the result received from a proxy with a result produced by the agent and send the combined results to the entity that interacted with the agent. An interaction may be related to or associated with an operating system, a third party component, a software module, a hardware component, a system call, a hardware or software interrupt, an interaction with an application program interface (API) or an activation of an application software development kit SDK component. For example, an interaction may include accessing a resource of an operating system, a file or the like, or it may be accessing a hardware component (e.g., a disk, a memory etc.) or an interaction may include performing a system call. As described herein, any interaction with an agent on a first machine (e.g., a virtual machine) may be intercepted, analyzed and operations needed to be performed may be divided between the agent (that may perform its part on a local machine) and a proxy that may perform its part on a remote machine or on a virtual machine other than the virtual machine on which the agent is executed.

As shown by the arrows connecting proxy 2035 and mediators 2015 and 2025, proxy 2035 may communicate with mediators 2015 and 2025, e.g., proxy 2035 may provide any one of mediators 2015 and 2025 with a result of an operation. For example, mediator A 2015 may receive a message destined to agent 2020, may analyze the message based on a policy and determine that a first and second operations need to be performed. Mediator A 2015 may further determine that the first operation is to be performed by proxy 2035. Accordingly, mediator A 2015 may communicate information and/or a command to proxy 2035 that may, based on a command received from mediator A 2015, perform an operation or task. Proxy 2035 may be configured to provide any result or other information to any one of mediators 2015 and 2025. For example, upon completing a task or operation, proxy 2035 may determine or receive a result and may forward the result to any one of mediators 2015 and 2025. Any one of mediators 2015 and 2025. may process a result received from proxy 2035, may combine the result with information received from agent 2035 to produce a combined result, and may provide the processed and/or combined result to a sender of an original request. In some cases, any one of mediators 2015 and 2025. may forward a result from proxy 2035 as received.

For example, if a requested task or operation is fully performed by proxy 2035, agent 2020 may receive a result from proxy 2035 and may simply forward the result to the requestor. In other cases, mediator A 2015 may determine that some or a first portion of the task is to be performed by agent 2020 and a second portion of the task is to be performed by proxy 2035. In such case, a result received from proxy 2035 may be combined with a result produced by agent 2020 and the combined results may be provided to the entity that requested performance of the task. Upon breaking a task into portions to be performed by agent 2020 and proxy 2035, mediator A 2015 may inform agent 2020. Accordingly, after completing a task, agent 2020 may wait for a result from proxy 2035, combine the result received from proxy 2035 with a result produced by agent 2020 and provide the combined result. For example, management unit 1010 may request agent 2020 to perform a task (e.g., as shown by 2010). Mediator A 2015 may intercept the request and determine (e.g., as shown by 2016) a first portion of the task is to be performed by proxy 2035 and a second portion of the task is to be performed by agent 2020. When proxy 2035 completes performing the first portion of the task it may return a result to agent 2020 that may combine the result received from proxy 2035 with a result of a local performance of a second portion of the task and may send the combined result to an origin of the request intercepted by mediator A 2015.

Either in performing a task as described herein or during other operations (e.g., periodic operation performed by agent 2020 that may be unrelated to received requests), agent 2020 may attempt to perform local operations, e.g., access a file, update a registry, receive services from an operating system (e.g., OS services, memory services, mutex, COM, RPC, etc.). Mediator B 2025 may intercept or otherwise detect any attempt made by agent 2020 to access or use a local resource. For example, any attempt made by agent 2020 to interact with any entity or resource on local machine A may be intercepted. As shown by 2026, mediator B 2025 may analyze any operation performed by agent 2020 and determine whether the operation or a portion of a task will be performed locally, e.g., by agent 2020 or another module on local machine A or performed on remote machine B. If mediator B 2025 determines that an operation, task or portion thereof are to be performed on the remote machine B, mediator B 2025 may interact with proxy 2035, provide proxy 2035 with any information or parameters needed (e.g., a file name, a registry entry etc.) and may cause proxy 2035 to perform a task, a portion of a task or an operation. Upon completion of performing an operation based on input from mediator B 2025 proxy 2035 may provide agent 2020 with any related result. As shown by local execution 2030, in case mediator B 2025 determines that an operation is to be performed locally, mediator B 2025 may enable agent 2020 to perform the operation or it may transfer execution of the operation to a local entity (e.g., a local kernel of a local operating system or local application).

Accordingly, a request to perform a task or operation related to an agent installed in a first machine, e.g., a request directed to an agent on a local machine or an operation attempted by an agent on a local machine may be intercepted and analyzed. Based on an analysis result of the request or attempted operation, a first portion a requested task may be performed by the agent and a second portion of a requested task may be performed by a proxy on a remote machine. For example, the local and remote machines may be virtual machines installed on the same physical server. Calls made to the agent and calls made by the agent may be intercepted and analyzed as described herein. For example, system calls made by agent 2020 may be intercepted by mediator B 2025 and, rather than performing the system call on local machine A, using proxy 2035, the system call may be performed on remote machine B. Likewise, calls or other interactions (e.g., interrupts) that may be configured to be handled by agent 2020 may be intercepted by mediator A 2015 and may be handled, wholly or partially by proxy 2035 rather than by, or in conjunction with, agent 2020. In an embodiment, a call, request or interaction related to agent 2020 may be intercepted and/or analyzed by mediator A 2015 prior to being delivered or otherwise made available to agent 2020.

It will be understood that any number of agents 2020 may be installed on machine A and any number of proxies 2035 may be installed on one or more remote machines B. Mediators A and B may associate any number of agents with any number of proxies. For example, mediator A 2015 may cause a proxy 2035 to perform operations for a plurality of agents 2020. Mediator 2015 may cause a plurality of proxies 2035 to perform operations for a single agent 2020. Any other combinations may be made possible. For example, based on a configuration file mediators 2015 and 2025 may redirect operations from any number (including one) of agents 2020 to any number (including one) proxy 2035.

Exemplary tasks or operations that may be performed by a proxy instead of (or in conjunction with) an agent may be reading data related to a virtual machine or related to an operating system running in a virtual machine. For example, management unit 1010 may request agent 2020 to read a registry of an operating system. Rather than letting agent 2020 to read the registry on an operating system executing on machine A, mediator A 2015 may cause proxy 2035 to read the registry on an operating system executing on machine B. Similarly, a request to modify data (e.g., a file, a configuration parameter or any resource of a virtual machine or an operating system) may be redirected from an agent 2020 to a proxy 2035. Accordingly, a user or application (e g , management unit 1010) may request an agent on a first machine to perform a task and may be provided, by the agent, with a response or result but may be unaware that the task was not performed by the agent but rather, by a proxy on a second machine.

As described herein, multiple agents may be installed on a first machine and may be associated with multiple proxies on a plurality of remote machines or virtual machines. In some embodiments, a number of similar or even identical agents may be installed on a first machine and may each be associated with a remote machine and/or proxy. For example, module-1 1020 and module-2 1025 may both be instances of the same monitoring agent installed twice in management interface unit 1015 in association with system-A 1050 and system B 1040. In some embodiments, only one instance of an agent may be installed and some or all installation components may be duplicated, cloned or repeated. For example, an installation of an agent may include placing files in C:\program files\[AGENT_A\. When installing a number of similar or identical agents, files in folder C:\program files\[AGENT_A\ may be copied to C:\program files\[AGENT_B\, C:\program files\[AGENT_C\ etc. Similarly, registries may be duplicated (e.g., under different names) and/or any other parameters may be reproduced such that a single executable code (or a number of threads) may be executed to implement any number of agents that may be associated with any respective number of machines and/or proxies. In this example, C:\program files\[AGENT_A\ and C:\program files\[AGENT_B\ are essentially identical agents related to VM ‘A’ and VM ‘B’. In such case, the mediation layer may intercept calls made by the agent and redirects relevant calls to the new directory “C:\program files\[AGENT_A\”. In the same manner, an agent's calls to registry, mutex COM, RPC, named pipes, events, and substantially all named objects may be altered to include the altered path or name.

Reference is made to FIG. 1F which shows a schematic block diagram of a method according to embodiments of the present invention. As shown by block 3010, an agent may be analyzed. As described herein, analyzing an agent may include analyzing code, an operation, an installation and/or an execution of an agent. For example, code of a monitoring agent or a backup agent may be analyzed to determine core functionality of the remote agent that must be executed on the relevant machine, e.g., by a proxy. For example, if a CPU utilization of machine B is requested from agent 2020 then the operation of reading CPU registers or other information must be performed on machine B since performing the operation by agent 2020 on machine A would not produce the CPU utilization of machine B as requested. However, allocating memory (e.g., for storing temporary information) may be performed by agent 2020 on machine A even if the information to be stored in allocated memory is related to machine B.

As described herein, a policy or configuration may be generated and upon determining an action is to be performed, or a resource is to be accessed or used, the policy may be used in selecting a machine on which the action will be performed and/or the resources will be accessed. For example, to generate a policy or configuration information, a code segment of an agent may be analyzed to determine resources being accessed (e.g., files, semaphores, COM, RPC, input/output (I/O) devices etc.). To generate a policy or configuration parameters, an execution of an agent may be monitored and analyzed. For example, an agent may be executed and resources being accessed during execution may be determined. To generate a policy or configuration parameters, an installation of an agent may be monitored and/or analyzed. For example, folders in which files are placed during installation may be determined or registries updated or modified may be recorded. Accordingly, a policy or configuration may be based on various aspects related to an agent, e.g., analysis of a code segment of an agent, an execution of an agent and an installation of an agent. Analyzing an agent as described herein enables embodiment of the invention to supervise and control an operation or execution of an agent. For example, any attempt made by an agent to interact with a resource (e.g., open a file, update a registry, enable a hardware resource) may be intercepted. Interactions of an agent with any resource may be processed and/or analyzed and a machine on which the interaction is to be performed may be selected. For example, if an interaction of an agent with a memory (e.g., temporarily storing information in the memory) is intercepted, embodiments may cause the agent to store the information locally, e.g., on a management's hardware or virtual machine on which the agent is running. In another case, embodiments of the invention may intercept an attempt made by an agent to modify a local operating system registry and cause a proxy executed on a remote hardware machine or on another virtual machine to modify the registry on a remote operating system on a remote machine, or on a virtual machine other than the management, local machine.

By analyzing agent code as shown by 3010, embodiments of the invention may determine, as shown by 3015, possibly for each operation or task performed by an agent, whether the operation or task may be performed by the agent or may (or must) be performed by a proxy. As shown by 3020, if it is determined that an operation or task is to be performed locally (by the agent) the operation or task is marked accordingly and/or a file is updated to reflect such condition. Similarly, if an operation or task is to be performed by a proxy on a remote or target machine, the operation or task is marked accordingly and/or a file is updated to reflect such condition. As shown by 3030, a policy may be generated based on a result of an analysis of an agent's code. As further shown by 3035, a configuration file may be generated based on the analysis and/or the policy. For example resources accessed, files opened, semaphores or mutual exclusion (mutex) objects accessed or used may all be examined in order to determine a policy or configuration according to which mediators 2015 and 2025 may operate. For example, a policy may dictate how or where to route operating system interactions. For example, a policy may dictate how to manipulate the operating system interactions whether done local or remote. For example, for each system call used by an agent, a parameter in a configuration file indicating how to route the call may exist. For example, a parameter or entry related to routing system calls may be based on analysis of the system call parameters, a related dynamic linked library (DLL), a context, a call stack and/or a current state. Application programming interfaces (APIs) used by an agent may be examined to determine any relevant information, e.g., parameters or arguments used etc. Accordingly, in dividing performance of a task between an agent and a proxy, a mediator such as mediator 2015 or 2025 may cause an agent 2020 to use a first API on machine A as part of performing a task and cause a proxy 2035 to use a second API on machine B as part of performing the same task. Any other aspects, e.g., encryption of communication between entities, which operations or tasks to intercept and/or examine and the like may all be included in a configuration and/or policy that may be generated as shown by 3030 and 3035.

As shown by 3040, a configuration and policy may be used to operate mediators, e.g., mediators 2015 and 2025 may operate based on a policy and/or configuration produced as described herein. Code of proxy 2035 (or module-1A 1055, module-2A 1056 or modules in system-B and system-C shown in FIG. 1D) may be designed based on analysis of an agent (e.g., analysis of an agent's code, installation and/or execution) and/or a policy or configuration as shown in FIG. 1F. For example, a proxy may be designed according to operations that may be required where the required operations may be determined by analyzing code of the relevant agent. For example, after determining the operations that may be performed on a remote machine (or on a virtual machine other than the virtual machine on which an agent is installed), a proxy module may be designed to best perform such operations. Accordingly, a policy generated by analyzing a code segment of an agent may be used to determine an operation to be performed by a proxy.

Referring now to FIG. 1A, a block diagram depicts an embodiment of a physical device executing at least one guest virtual machine (VM) 101. In one embodiment, a guest virtual machine 101 executes software, which may be referred to as, by way of example, and without limitation, software agents, software services, software plugins, or software add-ons 103. FIG. 1A depicts one embodiment of a conventional system executing virtual machines. In some typical environments, software agents 103 are installed on one or more computing devices 101 to perform various operations required by a management station 106 for various management tasks such as, without limitation: system management (which may include monitoring), software distribution, database management, homegrown agent-based application, patch application, backup, storage, storage management, business service management (BSM), asset management, license management, security application such as anti virus or endpoint security, configuration management (CMDB), or any other software service or operations that may be performed on one or more computing device 101 controlled by the management server 106.

Referring still to FIG 1A, the guest virtual machines 101 (which may be referred to hereafter as “guest VMs 101”), are executed in a virtual environment. A virtual environment is technology that enables multiple servers/desktops to be executed on a single physical host. This technology employs a hypervisor 104 that virtualizes the physical HW and mediates between the virtual machines 101 and the physical hardware of the physical host machine 102.

In some virtualization environments, a computing device includes a hypervisor layer, a virtualization layer, and a hardware layer. The hypervisor layer includes a hypervisor 104 that allocates and manages access to a number of physical resources in the hardware layer (e.g., the processor(s) and disk(s)) by at least one virtual machine executing in the virtualization layer. The virtualization layer includes at least one operating system and a plurality of virtual resources allocated to the at least one operating system. Virtual resources may include, without limitation, a plurality of virtual processors and virtual disks, as well as virtual resources such as virtual memory and virtual network interfaces. The plurality of virtual resources and the operating system may be referred to as a virtual machine 101.

A hypervisor 104 may provide virtual resources to an operating system in any manner that simulates the operating system having access to a physical device. A hypervisor 104 may provide virtual resources to any number of guest operating systems. In some embodiments, a computing device executes one or more types of hypervisors. In these embodiments, hypervisors may be used to emulate virtual hardware, partition physical hardware, virtualize physical hardware, and execute virtual machines that provide access to computing environments. Hypervisors may include those manufactured by VMWare, Inc., of Palo Alto, Calif.; the XEN hypervisor, an open source product whose development is overseen by the open source Xen.org community; HyperV, VirtualServer or virtual PC hypervisors provided by Microsoft, or others. In some embodiments, a computing device executing a hypervisor that creates a virtual machine platform on which guest operating systems may execute is referred to as a host server.

In some embodiments, a hypervisor 104 executes within an operating system executing on a computing device. In one of these embodiments, a computing device executing an operating system and a hypervisor 104 may be said to have a host operating system (the operating system executing on the computing device), and a guest operating system (an operating system executing within a computing resource partition provided by the hypervisor 104). In other embodiments, a hypervisor 104 interacts directly with hardware on a computing device, instead of executing on a host operating system. In one of these embodiments, the hypervisor 104 may be said to be executing on “bare metal,” referring to the hardware comprising the computing device.

In some embodiments, the hypervisor 104 controls processor scheduling and memory partitioning for a virtual machine 101 executing on the computing device. In one of these embodiments, the hypervisor 104 controls the execution of at least one virtual machine 101. In another of these embodiments, the hypervisor 104 presents at least one virtual machine 101 with an abstraction of at least one hardware resource provided by the computing device. In other embodiments, the hypervisor 104 controls whether and how physical processor capabilities are presented to the virtual machine 101.

In one embodiment, the guest operating system, in conjunction with the virtual machine on which it executes, forms a fully-virtualized virtual machine which is not aware that it is a virtual machine; such a machine may be referred to as a “Domain U HVM (Hardware Virtual Machine)”. In another embodiment, a fully-virtualized machine includes software emulating a Basic Input/Output System (BIOS) in order to execute an operating system within the fully-virtualized machine. In still another embodiment, a fully-virtualized machine may include a driver that provides functionality by communicating with the hypervisor 104; in such an embodiment, the driver is typically aware that it executes within a virtualized environment.

In another embodiment, the guest operating system, in conjunction with the virtual machine on which it executes, forms a paravirtualized virtual machine, which is aware that it is a virtual machine; such a machine may be referred to as a “Domain U PVM (Paravirtualized Virtual Machine)”. In another embodiment, a paravirtualized machine includes additional drivers that a fully-virtualized machine does not include.

Referring still to FIG. 1A, and by way of example, without limitation, to use the technology described in the “Nagios” project, the agents 103 may be NRPE or nsclient++ and the agent management station may be a “Nagios” management component 106. NRPE or nsclient++ are software products that may be installed on each server in monitored environments. These are only some examples of software agents 103.

Referring still to FIG. 1A, the guest VMs 101 can be servers such as: application servers, file servers, proxy servers, network appliances, gateways, application gateways, gateway servers, virtualization servers, deployment servers, SSL VPN servers, firewalls, web servers, mail servers, security servers, database servers or any other server application. In other embodiments, a guest VM 101 may provide a user with access to a virtual desktop environment. The methods and systems described herein may be implemented in both types of environments to reduce certain burdens on information technology (IT) departments. For example, conventional IT departments may invest large operational efforts to deploy and manage software agents 103 while taking downtime risks on their service in order to do so. In some embodiments, system management products, security products or other products that rely upon software agents 103 to reside within a virtual machine 101 may compromise the security or integrity of one or more of these software agents 103.

FIG. 1B is a block diagram depicting an embodiment of a method to execute software agents 103 on guest VMs 101 without installing them on the virtual machines 101 and without placing the process of the agent 103 on the guest VMs 101. As shown in FIG. 1B, one or more of the software agents 103 are not installed on each guest VM 101 but rather installed and executed partially on a new dedicated virtual machine or virtual appliance 122 while part of the execution may still occur on the guest VM 101. The agent process 121 is executed on and uses the agent virtualization VM 122 to read and/or write information and execute operations on the guest VM 101.

In some embodiments, executing the agent process 121 from the agent virtualization VM 122 may improve the stability of a guest VM 101 and may prevent compatibility issues between different agents 121 that would otherwise need to execute on the same guest VM 101. In addition, virtualizing software agents 121 may have a positive impact on existing functionality and/or performance and/or memory consumption and/or CPU usage and/or storage and/or disk usage and/or any I/O and or networking and/or any other execution parameter of the guest VM 101.

Referring now to FIG. 1B, and in greater detail, the virtualization platform 122 is designed to execute the agent software 121 in a central place while performing only limited operations on the guest VM 101. In some embodiments, the virtualization platform 122 executes all the processing without executing anything on the guest VMs. The virtualization platform 122 may be referred to as a virtual appliance 122, a virtual appliance virtual machine 122, a VA VM 122, a virtual appliance VM 122, agent virtualization VM 122, an agent virtualization VM on a virtualization appliance 122, or a VA 122. The virtualization platform 122 may execute one or more agents. In some embodiments, the agents 121 may service one or more guest VMs 101 therefore functionality is provided allowing a user to define for each agent 121 which guest VMs 101 it services.

Referring still FIG. 1B, in one embodiment, the role of the agent virtualization VM 122 is to execute an “off the shelf” agent on a dedicated VM 122. “Off the shelf” agents may refer to standard commercially available products that need not undergo any code changes to fit to the new architecture. Nevertheless, in some embodiments of the methods and systems described herein, although the agent 121, which was designed to retrieve information or perform changes on the guest VMs 101, is not installed in its entirety within a guest VM 101, the agent 121 may still provide the same functionality of retrieving information and making changes on remote VMs 101. For example, for an agent 121 that tests the CPU usage of a machine and executed on the agent virtualization VM 122, the CPU test API calls generated by the agent 121 are intercepted by the agent virtualization VM 122 and may be executed on the guest VM 101 to provide the agent 121 with the requested information; alternatively, the agent virtualization VM 122 may leverage information gathered using different heuristics, such as information received from a virtualization infrastructure vendor to provide the virtualized agent 121 with the required information.

An agent 121 is executed on the agent virtualization VM 122 that simulates the OS of the guest VM 101 for the executed agent 121. The agent virtualization VM 122 intercepts the interactions of the agent 121 to the OS (that is the guest VM 101's OS) such as API calls, system calls, IPC, HW interactions, network interactions, disk interaction, kernel interactions and any other form of interaction with the OS hosted on the guest VM 101 and translates these interactions so that some of them happen in the context of the guest VM 101 thus achieving the same functionality as if the agent were installed on the guest OS 101. Some of the interactions are executed locally on the agent virtualization VM 122 and some interactions are handled by the agent virtualization VM 122 that in turn, uses the hypervisor 104 or the virtualization infrastructure to retrieve the needed information.

Referring still to FIG. 1B, in one embodiment the agent virtualization VM 122 operates independently of the software agent code 121. In one embodiment, there is no need to alter or integrate with the software agent as the systems and methods describe herein allow viewing the agent as a “black box” whereby virtualizing agents does not require any changes to the core of the agent 121 and tasks may be completed without requiring integration with or from the vendor of the agent 121. In another embodiment, however, integration with some vendors may take place to smooth integration and improve efficiency/functionality—for example, supporting new software agents 121, different software agents versions, patches etc., may require configuration of the agent virtualization platform 122. Such configuration may be provided and downloaded automatically or manually to support the new features/agents 121.

The agent 121 may be pre-installed or installed on an agent virtualization VM 122. The agent virtualization VM 122 includes an update system which allows it to download support for new agents 121 or agent version, patches, plugins either from the internet, local network or via a local configuration file, or any other means of update suitable

The virtualized agent 121 may perform “passive” operations on the guest machines such as: monitoring, gather parameters, read files and read configurations and/or any operation which is a read-only in nature, meaning it doesn't change anything at the guest VM 101. In addition, a virtualized agent 121 may perform “active” operations such as writing files, changing configuration, opening communication channels, copying memory, changes to the kernel, interactions with hardware, performing persistence changes and/or any operation as if it was installed on the guest VM 101.

Referring still FIG. 1B, in order for the agent virtualization VM 122 to communicate with the guest VMs 101, a small process 123 is placed on each guest VM 101. This small process 123 serves as a function executer. It receives functions to execute from the agent virtualization VM 122, executes them on the guest VM 101, and returns the result to the agent virtualization VM 122. For simplicity, this process may be referred to as a proxy process 123 or a proxy 123. In one embodiment, the proxy process 123 is a very light and limited piece of code that resembles an RPC server. In some embodiments, the proxy 123 differs from an agent 121 in that, by way of example, and without limitation, the proxy 123 has a very small footprint on the machine. In other embodiments, the proxy 123 differs from an agent 121 in that, by way of example, and without limitation, the proxy 123 is distinct from a product type and version of the agent 121. In still other embodiments, the proxy 123 differs from an agent 121 in that, by way of example, and without limitation, there is only one instance of proxy for each guest VM 101 as opposed to a plurality of agents 121; in one such embodiment, the proxy 123 can communicate with the agent virtualization VM 122 to service dozens of virtualized agents 121, which may be different products or one or more versions of the same product.

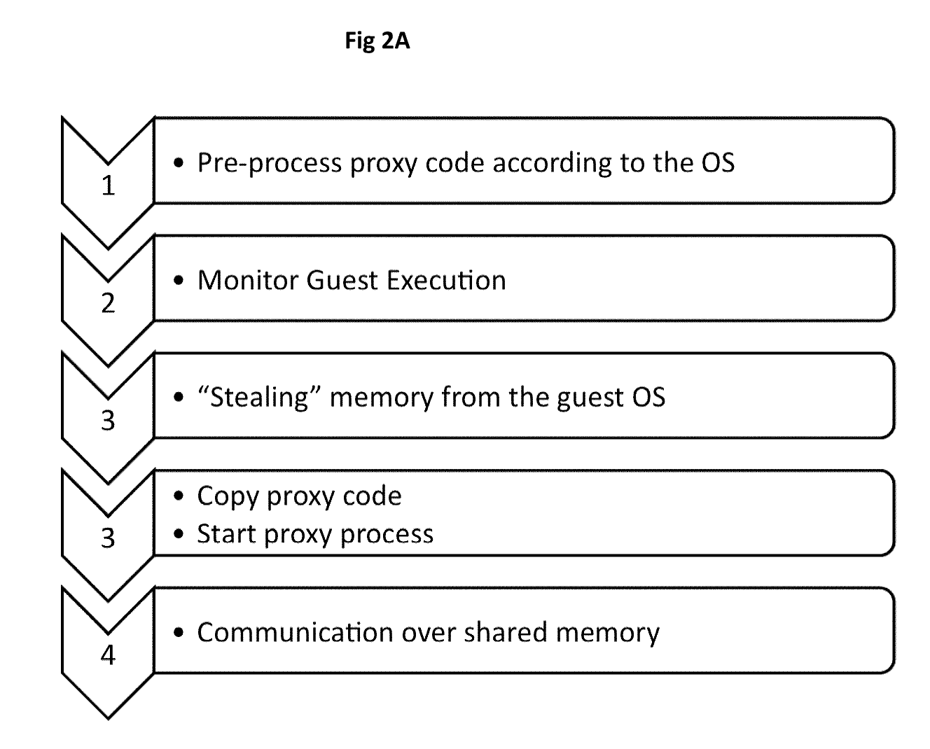

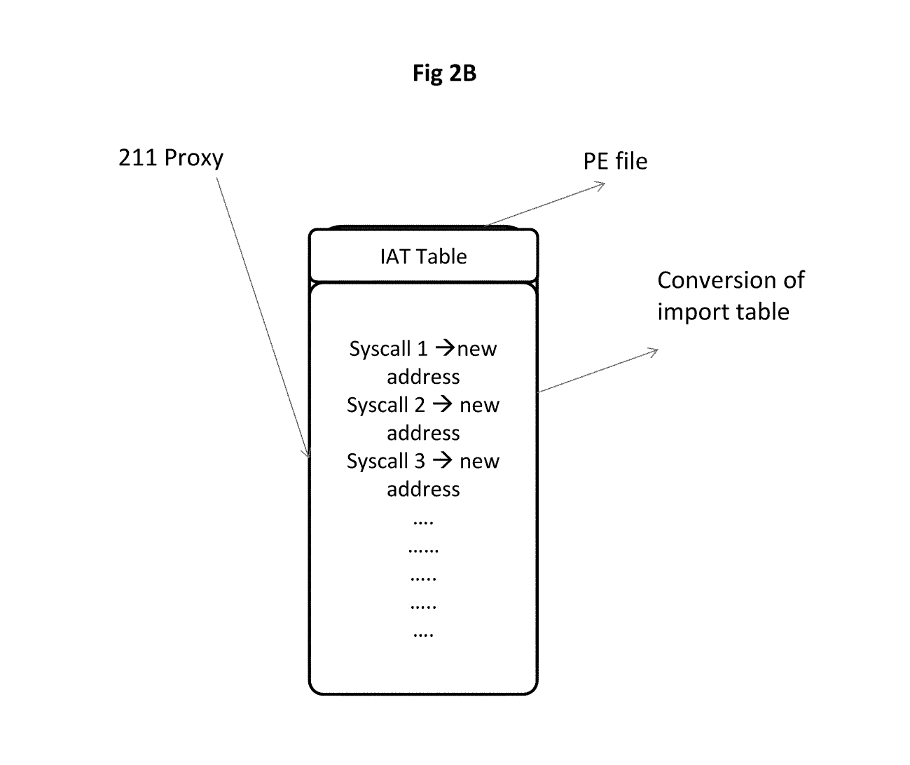

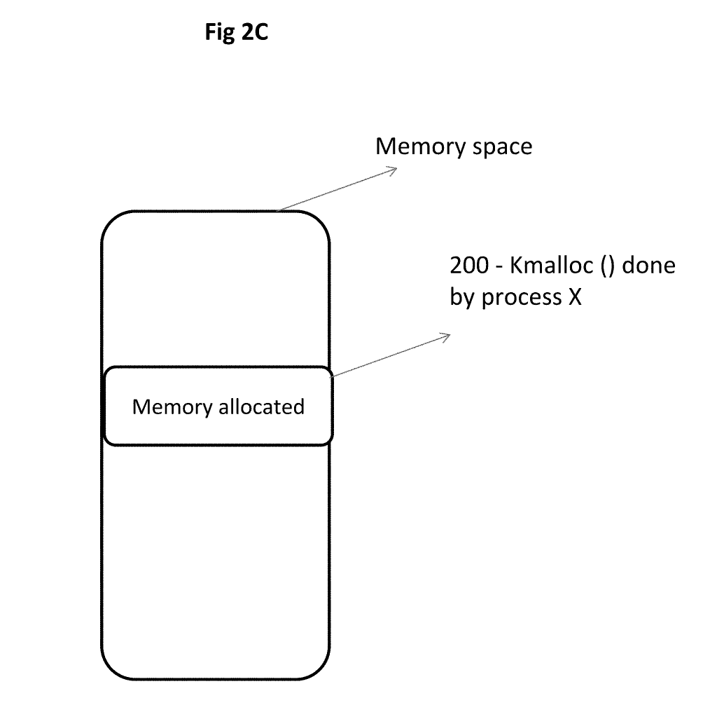

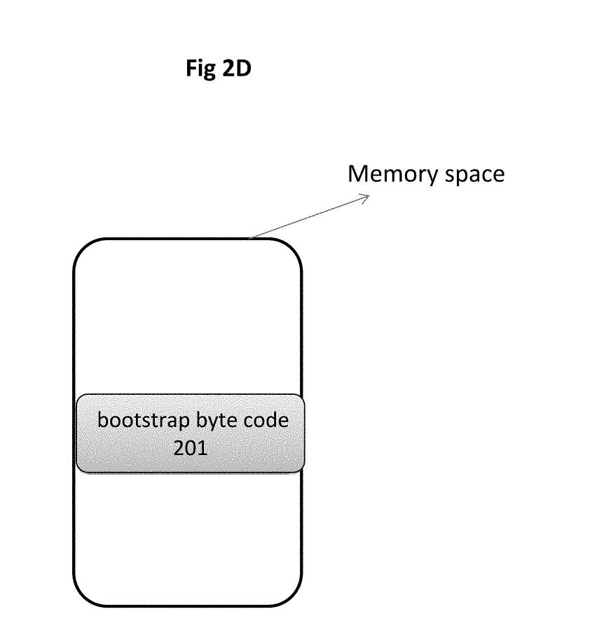

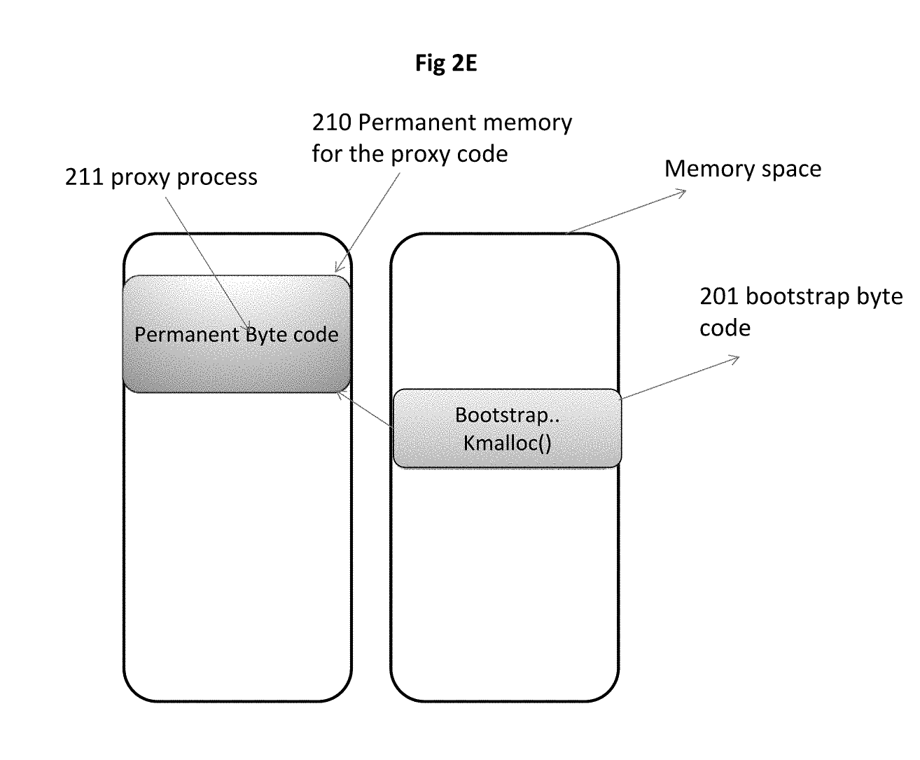

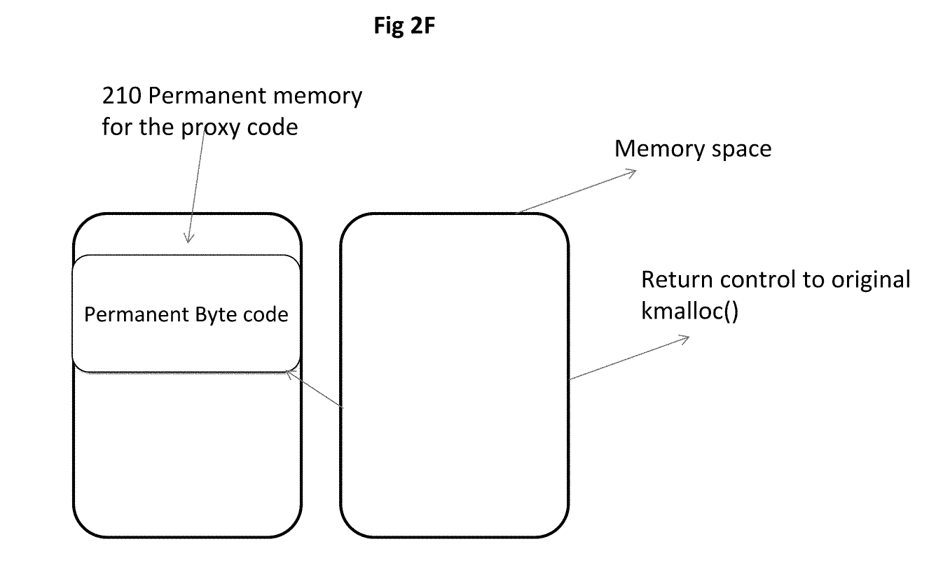

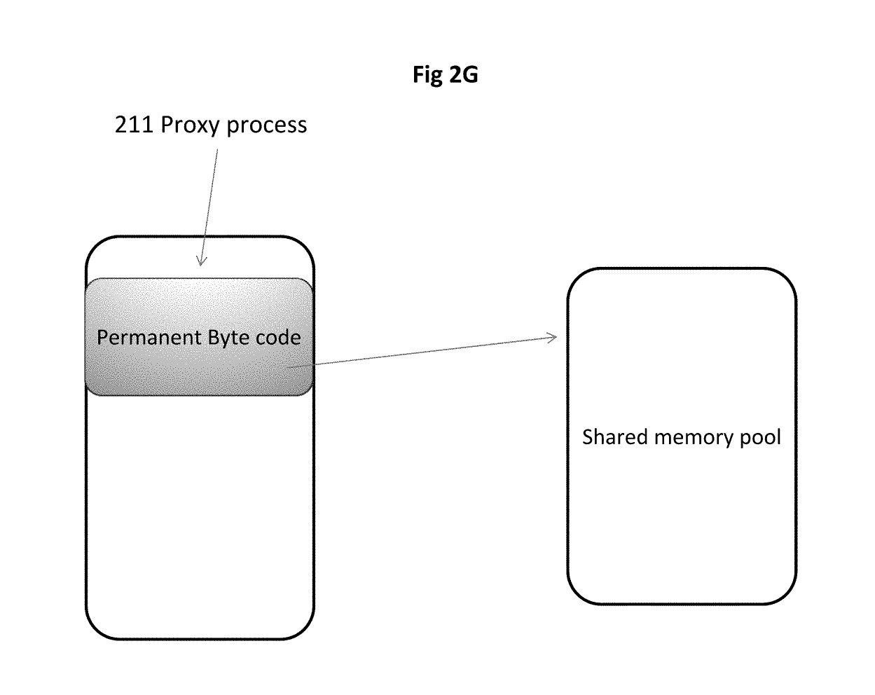

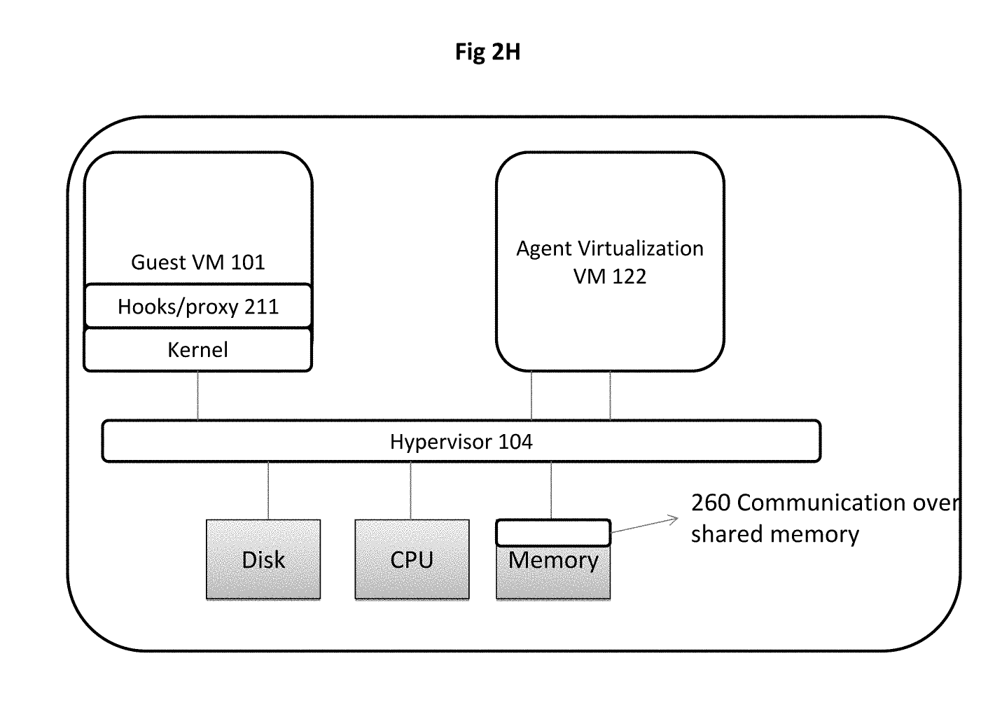

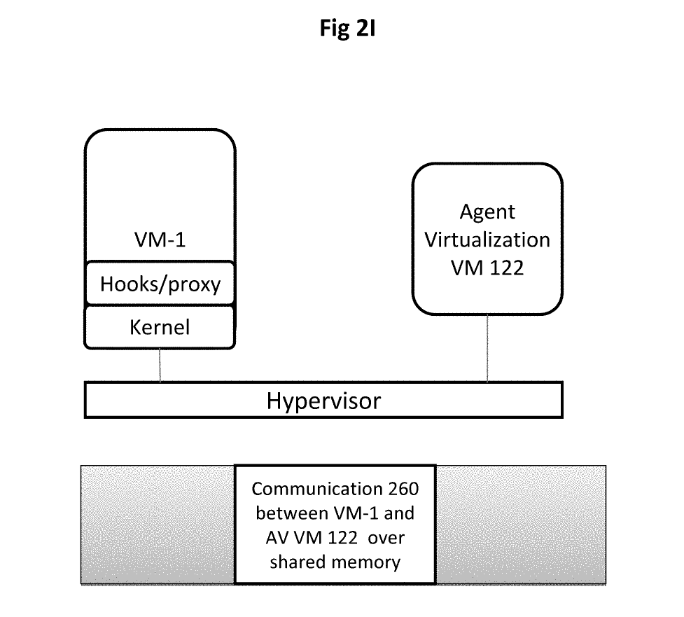

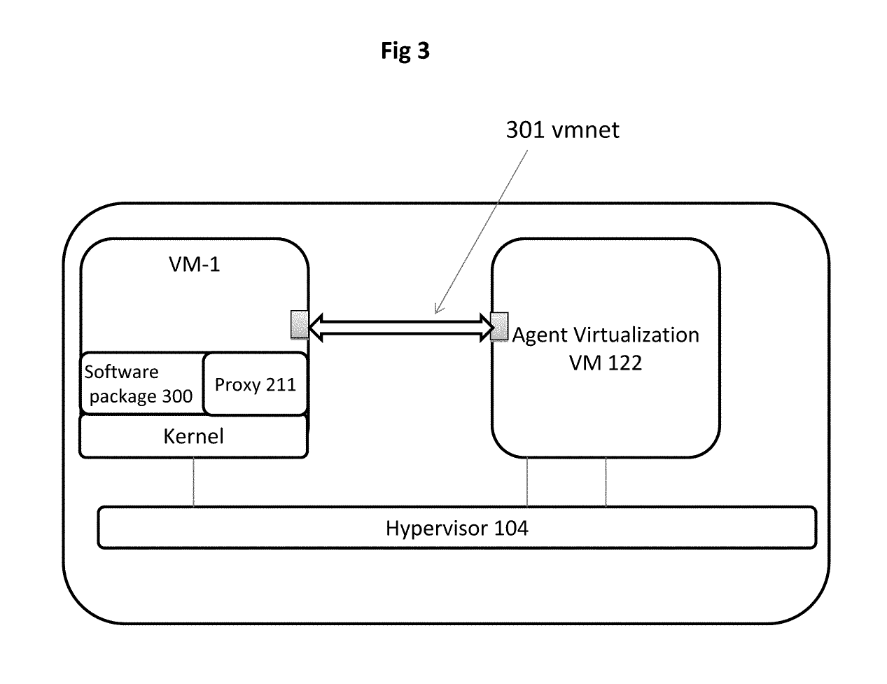

A further example is provided to expand upon differences between the proxy 123 and the agents 121. By way of example, for a datacenter in which 10 different agents are to be installed on each guest VM 101 in that datacenter, without implementation of the methods and systems described herein, an administrator would typically need to install each one of the 10 agents on each and every guest VM 101, configure the agents, maintain the agents, and upgrade the agents periodically. In conventional systems, this effort would have placed an increased burden on the administrator and, due to system downtime risks, on users. In contrast, in the methods and systems described herein, by the use of the proxy 123, which is automatically placed on the guest VMs 101 (as described below in connection with FIGS. 2A-FIG. 3) and by leveraging the agent virtualization VM 122, it becomes possible for an administrator to execute these 10 agents on the agent virtualization VM 122 while only a small portion of the work is executed using the proxy 123 on the guest VM 101. As a further example, if the administrator is then required to deploy an eleventh agent (for example, a CMDB agent), by leveraging the methods and systems described herein the administrator may install the eleventh agent once on the agent virtualization VM 122 and neither the proxy 123 nor the guest VMs 101 need to be changed, affected, rebooted or interrupted in any way. In some embodiments, therefore, the methods and systems described herein provide an improvement to administrative efficiency while decreasing the impact on users (administrators and clients alike) as well as the effect on stability of the server.

In some embodiments, the proxy 123 may include additional components to insure stability and supply further functionality such as: watch dog to assure proxy is functioning, monitoring/logging of proxy, debug of proxy and any other component which will be required to the execution of the proxy 123.

Referring still to FIG. 1B, the communication between the proxy 123 and the agent virtualization 122 occur within the physical host, thus achieving very low latency and very high throughput. In further detail, the system described herein leverages the inter-memory fast communication channel between independent virtual machines 101 that reside on the same physical host to create a distributed execution of software agents 121. In one embodiment, this fast performance channel improves the performance of the described system.

In some embodiments, the communication channel between the agent virtualization 122 and the guest VM is encrypted.

In some embodiments, the virtualized agent 121 may service not only guest VMs 101 but also the host machine 102 itself. In one of these embodiments, instead of installing the agent 121 on the host machine 102, it is possible to execute the agent 121 on the agent virtualization VM 122 from where it provides the same functionality as if it was installed on the host machine 102. In this embodiment the agent virtualization 122 provides a way to execute agents that normally would be executed on the host machine 102 thus delivering a solution that virtualizes the agents 121 from all guests VMs 102 and from all host machines 102.

A computing device of the sort depicted in FIG. 1B typically operates under the control of operating systems, which control scheduling of tasks and access to system resources. The computing device, and the guest VMs 101 that execute upon the computing device, can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 3.x, WINDOWS 95, WINDOWS 98, WINDOWS 2000, WINDOWS NT 3.51, WINDOWS NT 4.0, WINDOWS CE, WINDOWS MOBILE, WINDOWS XP, WINDOWS 7, and WINDOWS VISTA, all of which are manufactured by Microsoft Corporation of Redmond, Wash.; MAC OS, manufactured by Apple, Inc. of Cupertino, Calif.; OS/2, manufactured by International Business Machines of Armonk, N.Y.; and Linux, a freely-available operating system distributed by Caldera Corp. of Salt Lake City, Utah, or any type and/or form of a Unix operating system, among others. Additionally, the computing device can be any workstation, desktop computer, laptop or notebook computer, server, handheld computer, telephone, mobile telephone or other portable telecommunications device, media playing device, a gaming system, mobile computing device, or any other type and/or form of computing, telecommunications or media device that is capable of communication. The computing device has sufficient processor power and memory capacity to perform the operations described herein. Additionally, the operating system of the guest VMs 101 may be any version of any operating system or distribution that supports execution of a hypervisor that hosts and/or runs virtual machines. The physical host 102 may also be a virtual server that supports nested virtualization, which is the ability to run a hypervisor inside a virtual machine that is executed on a hypervisor 104.

FIG. 1C is a block diagram depicting an embodiment of the agent virtualization platform VM 122 and its interactions with the host machine 102 and the internal components (guest VM 101, hypervisor 104). The system includes one or more physical hosts 102 where each of the physical hosts includes the components described above in connection with FIG. 1B. Each agent virtualization VM 122 may be connected via TCP/IP or via virtualization infrastructure communication channel 153 as supplied by virtualization vendors to the agent management station 150. In some embodiments, the communication channel may be a combination of the following technologies: a LAN network (Local access network), a WAN (Wide area network), an encrypted connection such as VPN (Virtual private network) or SSL VPN (Secure sockets layer, virtual private network). For example, such embodiments may include one or more hosts 102 that are connected in a LAN network, this group of hosts is connected using a VPN tunnel over a WAN connection to a remote datacenter. For example, a group of hosts 102 reside in a local datacenter which is connected via an encrypted connection (VPN) to a remote group of hosts 101 which are leased or rented from companies like: Amazon web services, Rackspace, Microsoft, JustHost and Google. In such example, the hosts 102 are a hybrid of locally owned hosts 102 which are connected to leased or rented hosts which are located outside the local network. In other example, all the hosts 102 are owned and managed by companies like: Amazon web services, Rackspace, Microsoft, JustHost and Google.

Referring now to FIG. 1C, and in greater detail, the agent management station 150 may monitor, manage, read information or issue commands to the agent virtualization VMs 122. A user, such as an administrator, may manage the agent virtualization VM 122 by accessing each agent virtualization VM 122 locally or via the agent management 150. Using the latter (agent management 150) the user can monitor and perform maintenance operations on all the agent virtualization VMs 122. The agent management 150 may be in charge of deploying the agent virtualization VM 122 across a system or an agent virtualization VM 122 may be deployed manually to each physical host or by any other means of deployment/distribution (the user chooses). In addition, the agent management 150 may be in charge of maintaining the software agents 121 themselves, which may include, without limitation: install, uninstall, upgrade, downgrade, patch, logging, debugging, monitoring, stop/start and any other operation which can be done to the agent process 121.

Referring again to FIG. 1B, a VDI environment allows IT to manage and deploy multiple desktops on the same physical box. VDI may leverage a hypervisor on a datacenter server to virtualize the HW and allow for the several independent desktop operating systems to be executed in parallel on the same physical computer. VDI technologies may also require weaker machines to serve as the desktop machines since some of the processing is done in the datacenter. VDI technology differs from agent virtualization VM 122 technology in the sense that VDI virtualizes the physical hardware for the operating system; so for example, the operating system sees a disk even though there is no such physical disk. Agent virtualization 122 virtualizes the guest VM 101 for the agent to feel that it is executed there. VDI does not virtualize software agents nor does it intercept interactions with an OS. To further clarify the usage of both technologies, VDI is used to better manage desktops and improve hardware efficiency for desktops while agent virtualization 122 is aimed at minimizing the deployment effort of agents 103 and separate them from the guest VMs 101 they are servicing, improve hardware efficiency and improve performance. Some VDI technologies may use application streaming which executes the OS and application fully on the datacenter and transmits the screen view to each end point. Application streaming is basically different from agent virtualization 122 in that sense, since it uses the desktop as a simple terminal to view and experience what is happening on the server.

Referring now to FIG. 2A, a block diagram depicts a method for injecting the proxy 123 into the guest VM 101 as a method to introspect the guest VM 101. An alternative method is discussed in FIG. 3. The steps described in FIGS. 2A, 2B, 2C, 2D, 2E, 2F, 2G, 2H depict an optional method for communication and interrogating with VM. An alternate method is described in FIG. 3. Injecting the proxy 123 provides access to a guest VM 101 enabling the agent virtualization VM 122 to interrogate the guest VM's OS, read information, write information, perform operations, load code, configure the machine and/or perform any necessary operation on the guest VM 101 on behalf of the management server or the agent 121. FIGS. 2B-2I further explain the high level process described in FIG. 2A.

Referring to FIG. 2A, and in conjunction with FIG. 2B, one embodiment of a method for executing a proxy includes pre-processing a process execution format (a PE file) of the proxy 211. The method includes acquiring a memory chunk to copy the proxy process 211 to the guest OS 101. In one embodiment, this includes two steps: i) acquisition of an initial piece of memory to copy a bootstrap code whose purpose is to allocate permanent code to the machine and ii) copying the proxy process code and starting the proxy process by altering CPU operations. These steps achieved a working process (a proxy 211) on each guest VM 101. In order to be able to interact between a guest VM 101 and the agent virtualization VM 122, the two components may share a memory space, as depicted in FIG. 2A. In some embodiments, in order to perform operations such as shared memory mapping and hi-jacking CPU execution, such support is provided by the hypervisor vendor; alternatively, such support may be developed to enable such capability.

FIG. 2B is a block diagram depicts one embodiment of operations taken on a process's PE file. A PE file is a standard for process execution format. In some embodiments, the agent virtualization VM 122 reads the import table of the PE file and loads it into memory. In one of these embodiments, for each API used in the import table, the agent virtualization VM 122 translates the API to an address that is relevant to the guest VM 101. In other embodiments, instead of pre-processing the PE file and setting up static addresses, it may also use a method to dynamically decide which the correct address is during run time. In still other embodiments, the agent Virtualization VM 122 locates an export table for each guest OS (for example, if it is WINDOWS-based or Linux/Unix-based).

Referring now to FIG. 2C, a block diagram depicts an embodiment of a method for installing a proxy on a guest VM. The process of seamlessly injecting the proxy 123 includes the ability to monitor and intervene in the execution of other VMs. The hypervisor or the host may provide such functionality—for example, some hypervisor vendors developed functionality for accessing one VM from another VM. In some embodiments, APIs, SDK, DLLs or executable files provide this functionality. Using the ability to intervene in the execution process, the agent virtualization VM 122 detects memory pool allocations (such as kmalloc( ), takes control over the memory and gains control over the execution of the VM to put the process that allocates memory on hold.

Referring now to FIG. 2D, an embodiment of a method for installing a proxy on a guess VM includes copying a small piece of code (which may be referred to as a “bootstrap”) that allocates permanent code. In another embodiment, the method includes iterating over raw memory pages of the OS, finding a free page and copying the same bootstrap code to the free page. In still another embodiment, the method includes using other heuristics to find free memory and using those heuristics to copy the bootstrap code. Once bootstrap code is copied, the agent virtualization VM 122 may change a CPU execution path to execute the copied bootstrap code.

Referring now to FIG. 2E, and in one embodiment, execution of the bootstrap code results in allocation of a permanent memory space to accommodate the proxy code. Once bootstrap is executed, it results in permanent memory allocated on the machine, which allows for the copying of the proxy process code.

Referring now to FIG. 2F, the execution changes to the process that initiated the original kmalloc( ) call to continue normal operations. The proxy code is then triggered to execute a process using a timer, a service or any other asynchronous way to allow it to start the proxy process.

Referring now to FIG. 2G, a block diagram depicts an embodiment of a method for the allocation of one or more memory pages that are used to share information or commands between the guest VM 101 and the agent virtualization platform VM 122. The memory pages may be allocated by the guest VM and then mapped by the agent virtualization 122 or the other way around: allocated by the agent virtualization platform 122 and provide a mapping by the guest VM 101. This achieves the goal of having a single pointer which is valid in both OSs (that of 122 and that of 101).

Referring now to FIG. 2H, a block diagram depicts one embodiment of a system for communication between a guest VM and the agent virtualization platform VM over shared memory. FIG. 2H demonstrates at a high level how the guest VM 101 can view and edit the same memory page 260 as the agent virtualization VM 122. Using the shared memory, both entities (the agent virtualization VM 122 and the guest VM 101) may communicate (260), execute system calls, APIs, shared memory and all communications needed to execute the software agent process 121. FIG. 21 depicts in further detail an embodiment of a shared memory channel between the guest VM 102 and the agent virtualization platform 122.

Referring now to FIG. 2H, in another embodiment the communication between proxy 211 and agent virtualization VM 122 may be over TCP/IP sockets which will be opened between the agent virtualization VM 122 and the guest VM 102. In yet another embodiment, the communication may be using non-TCP/IP communication channels such as: USB, SCSI, parallel, serial, firewire, and/or file system.

Referring now to FIG. 3, a block diagram depicting another embodiment of a method for injecting a proxy process into a guest VM via direct memory access API and communicating with it. The method includes injecting the proxy process 211 into each guest VM 101. In some embodiments, virtualization vendors provide a software package 300 for installation on a virtual machine. In one of these embodiments, to deploy the proxy 211, the agent virtualization VM 122 edits the software package 300 and adds the proxy 211 to the software package 300. In other embodiments, the agent virtualization VM 122 may use automatic deployment tools to install the proxy 211. In still other embodiments, either the agent virtualization VM 122 or an administrator manually installs the proxy 211 onto each VM. In some embodiments, the hypervisor vendor (e.g., VMware, Citrix, Xen, Oracle, Microsoft, etc.) employs a technique to define a template of a virtual machine. In such embodiment, the proxy 211 can be added to such a template. Sections 2A to 2F illustrate the deployment of the proxy code via direct memory access while the method and system described in connection with FIG. 3 leverage the software package 300, which is installed by default on each VM, as a channel to deploy the proxy code 211. In yet other embodiments, a user can utilize software distribution tools or do a manual installation of the proxy.

Referring still to FIG. 3, the method includes creating a safe and efficient communication channel between all the VMs 101 and the agent virtualization VM 122. In some embodiments, this includes automatically installing a virtual interface 301 on each VM 101 and allowing each VM 101 to communicate with the agent virtualization VM 122 via the virtual interface 301. In one embodiment, this can be achieved by using an interface provided by a hypervisor vendor (e.g., VMware, Citrix, Xen, Oracle, Microsoft, etc.) that allows automatic configuration of the machines, addition of new interface card or other pieces of virtual hardware. In other embodiments, this can be achieved by using other virtual HW to perform such communication for example: define a shared disk between all VMs and use files as source of communication, use non-ip interfaces such as: USB, SCSI, parallel, serial, firewire or file system. In still other embodiments, the method includes securing this network to prevent a security breach of VM 101. This may be achieved, in one embodiment, by hardening the proxy code, segmenting the network between each VM 101 and the VA 122; for example, by setting a different VLAN for each pair (VM-VA).

In some embodiments, the agent virtualization VM 122 may take over TCP/IP communication between the guest VM 101 and the management station 106. In one of these embodiments, instead of a situation where each guest VM 101 communicates with the management station 106, the agent virtualization VM 122 will communicate with the management station 106 on behalf of the guest VM 101. This can decrease the bandwidth usage, decrease I/O usage on the machine and improve performance and security.

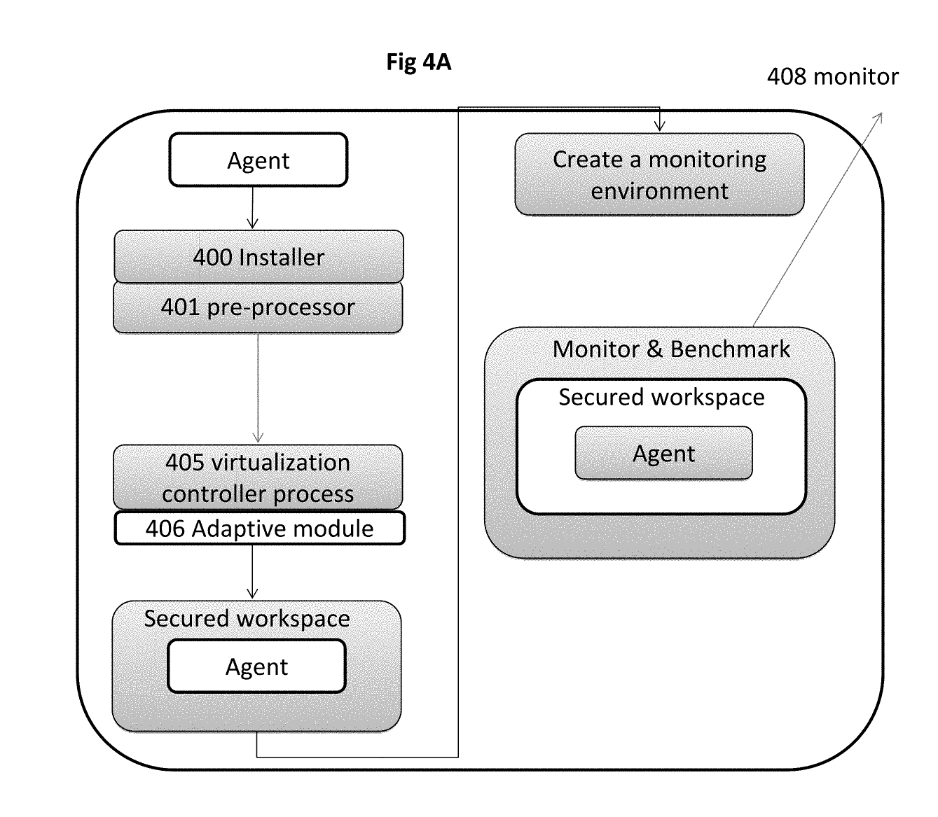

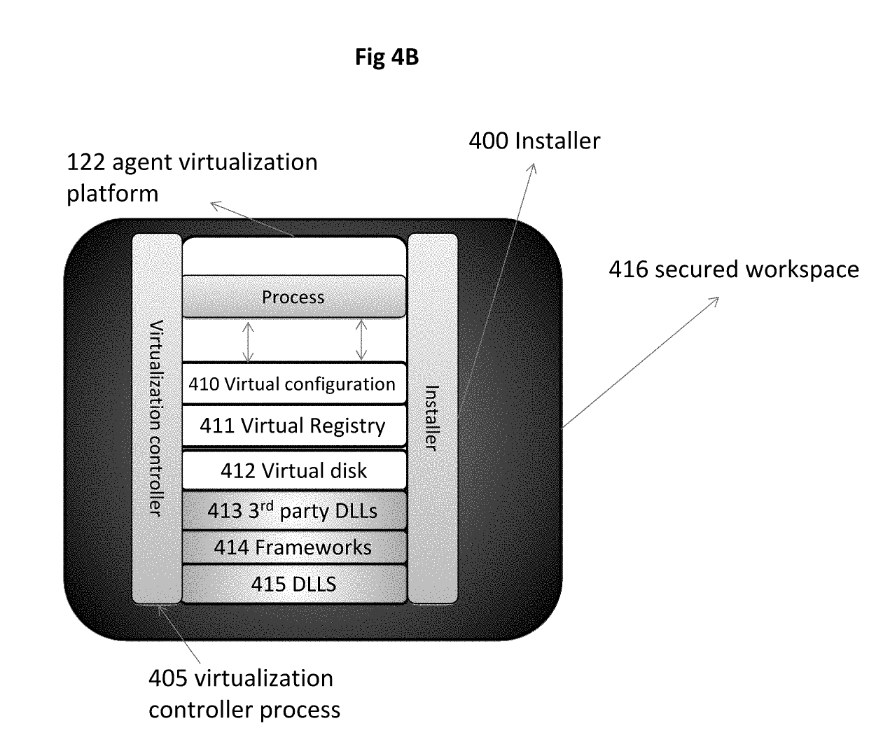

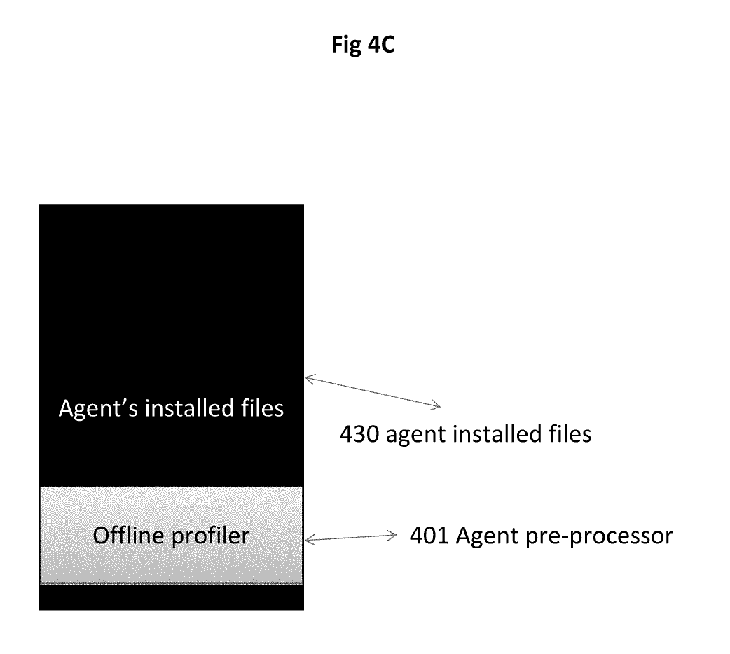

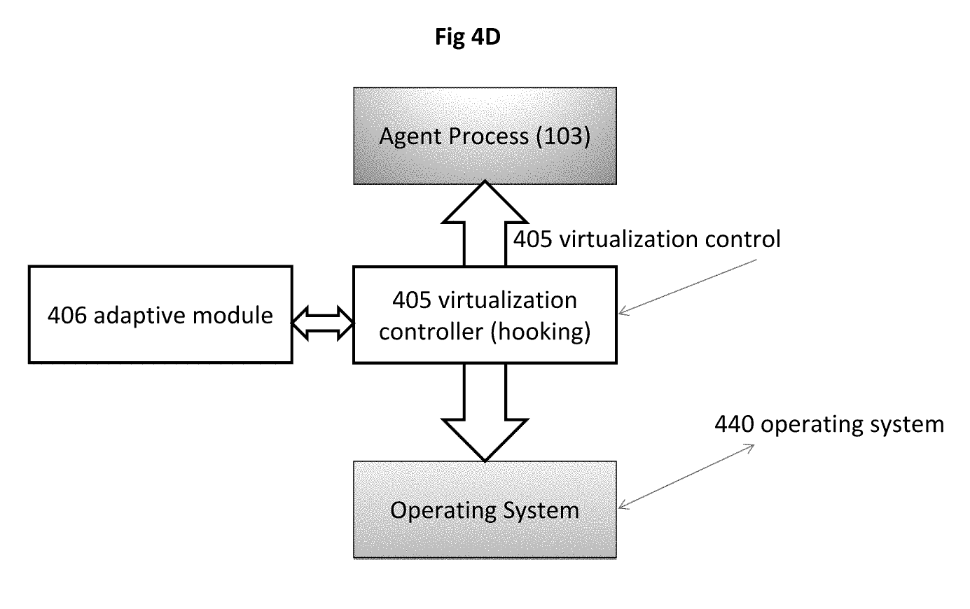

Referring now to FIG. 4A, a block diagram depicts an embodiment of an agent virtualization platform designed to execute agent processes. As shown in FIG. 4A, the agent virtualization VM 122 may include an installer 400, a pre-processor 401, a virtualization controller process 405, an adaptive module 406, and a monitor 408. These components may provide the functionality described above in connection with FIGS. 2A-2I. In one embodiment, when installing a new agent on the agent virtualization VM 122, the installer 400 is executed for a new agent 121. The installer 400 installs the agent 121 in a virtual workspace as will be further discussed in 4B.

Referring now to FIG. 4B, a block diagram depicts an embodiment of an agent virtualization VM 122 installer 409. In one embodiment, the installer 409 may be an integral part of the agent virtualization platform 122. In another embodiment, the installer 409 may reside outside the agent virtualization platform 122. In some embodiments, the installer 409 packages the agent 121 as an isolated unit. In one of these embodiments, the installer 409 packages dependent libraries, DLLs 415, frameworks 414, 3^{rd} party DLLs 413, executable, configuration files and databases in a space to be used by the newly installed agent 121. The installer 409 may put all these files in a specific partition on the disk or a dedicated library and sub-libraries. In other embodiments, the installer 409 creates a virtual configuration 410, virtual registry 411, and a virtual disk 412 that can process changes on the agent virtualization VM 122 without interacting with the proxy 123.

Referring now to FIG. 4B, and in greater detail, in one embodiment, the virtual registry 411 accommodates a work place to save configuration data for each agent 121 without affecting an actual registry on the agent virtualization machine 122. In one embodiment, the agents 121 reside in an autonomous space in order to avoid impacting the OS upon which the agents 121 execute. The agent process 121 is executed as if it saved the configuration and setting on the actual registry while the setting are actually saved on the virtual registry which is a minimized version of the real registry. In some embodiments, the virtualization controller 405 monitors the executed agent 121 and may hook system calls, API, processes, threads, and programs. Once the virtualization controller 405 detects an attempt to access the registry, it changes the call so that it instead accesses the virtual registry 411. In other embodiments, the virtualization controller 405 scans system calls for access to files. In one of these embodiments, the virtualization controller 405 identifies a file parameter within a call as a registry file, it alters the path parameter to include the virtual registry 405. In yet other embodiments, the virtualization controller 405 uses heuristics such as: automatic learning mode, statistical analysis, pre-configuration of each system call.

Referring still to FIG. 4B, the virtual registry 411 is a file which may be inherited from the machine original registry or from a clean machine or it may be a customized registry file. In some embodiments, the virtual configuration 410 may include those files belonging to the application and that are saving configuration data. In one of these embodiments, these files are saved and do not share the information with any other process nor allow other processes to alter these files. In other embodiments, the virtualization controller 405 allows only access to virtual files on the local OS and may not allow access to other places on the disk. In some agents, some calls to open/close files are executed on the remote machine (the guest VM 101). In some embodiments, 3^{rd} party DLLs 413, frameworks 414, local DLLs 415, which include, without limitation, APIs, add-ons, libraries, executable and other software used for the execution of the process, are grouped together by the installer 409 to achieve isolation and to decrease dependencies between installed agents 121.

In one embodiment, the virtual disk 412 is a controlled partition in which most of the agent processes 121 are executed. For example, if the agent 121 needs to save logs or debug information to a certain path: (example, c:\temp), the file is actually saved to c:\agent_x_special_partition\temp. The virtualization controller 405 may perform the translation to a path relative to the virtual disk 412.

In one embodiment, the secured workspace 416 is designed to achieve an isolated workspace that prevents an agent process 121 from changing or impacting other parts of the disk without control and authorization. The virtualization controller 405 monitors each operation done by the agent process 121 by hooking all interactions outside the process space (which may include System Calls, DLLs, imported function, etc.). The virtualization controller 405 may monitor the activity of the agent process 121 to detect abnormal behavior that may indicate a security attempt on the agent 121. Detecting such abnormalities may be done by using several methods such as: white list or black list for allowed operations for each process, parameters tests and validation of them, prevention of new process execution, and initiation of communication from the agent virtualization platform 122 to any location and other commonly used security practices.

The virtualization controller 405 may save information from some of the interactions and re-use that information to improve performance of the system. The system may be configured to cache some information (like specific files, specific parameters, APIs, system calls etc') or it may automatically learn which interactions it can save. Once these interactions are saved, it can leverage this information to apply efficient answers to these interactions. For example, when the agent virtualization 122 intercepts a request to read the file “config.ini” 100 times every second, it can save the file in memory and perform the interaction once every second. It may also employ mechanism on the proxy 123 to alert when the file changes on the guest VM 101 and use the cache version until then.

FIG. 4C depicts an embodiment of a system that inspects agent files 430. In one embodiment, an agent pre-processor 401 performs the inspection of these agent files 430. In another embodiment, the agent pre-processor 401 scans at least one agent files to detect the existence of executables, DLLs, configuration files, databases, temporary files and other relevant files. In some embodiments, the agent pre-processor 401 maps detected resources to a relevant data structure. In one of these embodiments, this data structure is used to understand the dependencies, the processes, threads, system calls, APIs, 3^{rd} party code, software relations, configuration and storage resources to be later used by the virtualization control 405. In other embodiment, the pre-processor 401 opens a file and maps it to a relevant category. For example, the pre-processor 401 scans a PE (portable executable) file to identify the system calls, APIs, imported functions, etc., and determines whether virtualization control hooking 401 is required and, if so, for which parts. As another example, the pre-processor 401 makes a list of configuration files, database files and storage files. During real-time hooking of the process, this list is used to understand the context of a call to open a certain file. If the file exists on the installed directory, it executes the open file locally; otherwise it may execute it on the endpoint VM 101. The pre-processor 401 performs the necessary hooking of the process, DLLs and all software ingredients and/or dependencies that require hooking. Hooking includes intercepting a call to a relevant system call, API, imported function etc., and allowing any change, deletion, change of API, change of parameters, etc., needed. In some embodiments, the hooking procedure itself might be done using “syscall proxing” and/or early hooking technic and/or detours and/or kernel hooks and/or user mode filters and/or dll injection.

Referring now to FIG. 4D, a block diagram depicts an embodiment of a system providing execution of an agent process 121. In one embodiment, the execution of the process 121 starts when a request to start execution is initiated. Such a command can be sent locally or sent from the management station 150. In another embodiment, the command is sent to the virtualization controller 405 and the command includes the agent 121 that needs to be executed, the list of VMs that needs to have that agent 121 running and a list of configuration parameters.

In some embodiments, the virtualization controller 405 executes the process 121 with the hooks installed on it. In one of these embodiments, the adaptive module 406 is designed to learn the behavior of the agent 121, understand the context of the operations the agent 121 performs, and gather real-time information about its operations. In another of these embodiments, the adaptive module 406 uses analytics to gain insights from these data and to feed commands to the virtualization controller 405 with new hooks, modified hooks, changes in configuration, debug, logs, auditing, etc.

Referring again to FIG. 4A, and in some embodiments, implementation of the methods and systems described herein results in execution of an agent 121 that uses a proxy 123 within the remote guest VM 101 to interrogate and change the remote guest VMs 101. Additionally, in other embodiments, a monitor 408 monitors these and other activities in order to achieve better insights on the agent 121 functionality, performance and operations. In one of these embodiments, the monitor 408 may include functionality for collecting statistical data, monitoring, logs and performance data from the machine. In another of these embodiments, the monitor 408 may transmit the collected information to the management 150 or to a command line interface or a local GUI.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. For example, some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor readable non-transitory storage medium, such as for example a memory, a disk drive, or a USB flash memory encoding, including or storing instructions, e.g., computer-executable instructions, which when executed by a processor or controller, cause the processor or controller to carry out methods disclosed herein.

The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, floppy disk, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

Having described certain embodiments of methods and systems for providing consumers with codes for authorizing payment completion via mobile phone communications, it will now become apparent to one of skill in the art that other embodiments incorporating the concepts of the disclosure may be used.

1. A method of executing a task, the method comprising:
generating a policy by monitoring and analyzing an execution of an agent installed in a first machine;
intercepting, by a mediator on the first machine, a request to perform at least one operation, wherein the request is destined to the agent, and wherein the request is intercepted, by the mediator, prior to being delivered to the agent;
analyzing the request according to the generated policy to produce an analysis result, the analysis result including a first list of operations to be performed, by the agent, on the first machine and a second list of operations to be performed on a second machine;
selecting, by the mediator and based on the analysis result, the second machine; and
performing the operations in the first list by the agent, on the first machine, and performing the operations in the second list by a proxy, on the selected second machine.

2. The method of claim 1, wherein the first and second machines are virtual machines.

3. The method of claim 1, wherein the policy is generated by analyzing a code segment of the agent to determine an operation to be performed by the proxy.

4. The method of claim 1, comprising receiving, by a mediator, information related to performing operations in the second list, by the proxy and incorporating the information in a result provided by the agent.

5. The method of claim 1, comprising intercepting a call made by the agent, determining at least one operation to be performed by a remote proxy and causing the remote proxy to perform the at least one operation.

6. The method of claim 2, wherein the first virtual machine includes a plurality of agents associated with the proxy.

7. The method of claim 2, wherein the first virtual machine includes a plurality of agents associated with a respective plurality of proxies installed in a respective plurality of virtual machines.

8. The method of claim 2, wherein the agent is associated with a plurality of proxies installed in a respective plurality of virtual machines.

9. The method of claim 2, comprising intercepting a request, made by the agent, to read data related to a virtual machine and determining to read the data from one of: the first virtual machine and the second virtual machine.

10. The method of claim 2, comprising intercepting a request, made by the agent, to read data related to an operating system and determining to read the data from one of: an operating system included in the first virtual machine and an operating system included in the second virtual machine.

11. The method of claim 2, comprising intercepting a request, made by the agent, to modify data related to an operating system and determining to modify the data in one of: an operating system included in the first virtual machine and an operating system included in the second virtual machine.

12. The method of claim 2, comprising intercepting an attempt to access a resource of an operating system and determining to access a resource associated with one of: an operating system included in the first virtual machine and an operating system included in the second virtual machine.

13. The method of claim 2, comprising:
intercepting an interaction involving the agent, the interaction related to at least one operation;
analyzing the interaction according to a policy to produce an analysis result;
selecting, based on the analysis result, a virtual machine on which the at least one operation is to be performed;
causing a proxy on the selected virtual machine to perform the at least one operation;
receiving a result related to performing the at least one operation by the proxy; and
providing a result related to the interaction based on the result received from the proxy.

14. The method of claim 12, wherein an interaction is associated with one of: an operating system, a third party component, a software module, a hardware component and a system call.

15. A system comprising:
a plurality of computing machines;
a mediator installed on a first machine, the mediator to:
receive a policy, the policy generated by monitoring and analyzing an execution of an agent installed in the first machine;
intercept, on the first machine, a request to perform at least one operation, wherein the request is destined to the agent, and wherein the request is intercepted, by the mediator, prior to being delivered to the agent;
analyze the request according to the generated policy to produce an analysis result, the analysis result including a first list of operations to be performed on the first machine and a second list of operations to be performed on a second machine;
select, based on the analysis result, the second machine; and
cause the agent to perform the operations in the first list and cause a proxy to perform the operations in the second list on the selected second machine.

16. The system of claim 15, wherein the first and second machines are virtual machines.

17. The system of claim 15, wherein the mediator is to:
select, based on the analysis result, a virtual machine on which at least one operation is to be performed;
causing a proxy on the selected virtual machine to perform the at least one operation;
receive a result related to performing the at least one operation by the proxy; and
provide a result related to the interaction based on the result received from the proxy.

18. The system of claim 15, wherein the first machine includes a plurality of agents associated with a respective plurality of proxies installed in a respective plurality of machines.

19. The system of claim 15, wherein the policy is generated by analyzing a code segment of the agent to determine a first portion of a task to be performed by the agent and a second portion of the task to be performed by a proxy.

20. The method according to claim 1 wherein the policy is generated based on monitoring an execution of an agent.

21. The method according to claim 1 wherein the policy is generated based on monitoring an installation of an agent.
